(19) United States
(12) Patent Application Publication
(10) Pub. No.: US 2024/0314476 A1
(43) Pub. Date: Sep. 19, 2024

(54) SPEAKER AND ELECTRONIC APPARATUS

(71) Applicant: Sony Group Corporation, Tokyo (JP)

(72) Inventors: Naoki Shinmen, Tokyo (JP); Koya Nomoto, Chiba (JP); Masaki Kamata, Tokyo (JP); Akihiro Nakata, Kanagawa (JP)

(73) Assignee: Sony Group Corporation, Tokyo (JP)

(21) Appl. No.: 17/927,338

(22) PCT Filed: May 24, 2021
(86) PCT No.: PCT/JP2021/019512

§ 371 Date: Aug. 10, 2023

(30) Foreign Application Priority Data
Jun. 1, 2020 (JP) 2020-095437

(51) Int. Cl. H04R 1/02; H04R 7/06; H04R 7/26

(52) U.S. Cl. CPC H04R 1/02; H04R 7/06; H04R 7/26

(57) ABSTRACT

There is provided a speaker, including: a diaphragm that includes a surface-layer member that has a first surface and a second surface on a side opposite to the first surface, a plurality of drive points used as a reference for transmission of vibrations being set at predetermined positions of the second surface, and a reinforcing member that includes a plurality of first reinforcing portions and one or more second reinforcing portions and is connected to the second surface of the surface-layer member, the plurality of first reinforcing portions being formed in a vicinity of the respective plurality of drive points, the one or more second reinforcing portions being formed to connect, in a state of being spaced apart from the second surface, between the plurality of first reinforcing portions.

### CROSS REFERENCE TO RELATED APPLICATIONS

This application claims the benefit of Japanese Priority Patent Application JP 2020-095437 filed Jun. 1, 2020, the entire contents of which are incorporated herein by reference.

### TECHNICAL FIELD

The present technology relates to a speaker and an electronic apparatus.

### BACKGROUND ART

Patent Literature 1 discloses a speaker including a flat-plate shaped composite diaphragm having skins attached on both sides of the core. By appropriately defining the materials of the core and the skin of the composite diaphragm, it is possible to raise the divided variation value. As a result, the acoustic characteristics of the speaker has been improved (page 3, left column, lines 2 to 6, etc. of Patent Literature 1).

### CITATION LIST

### Patent Literature

### PTL 1

Japanese Examined Patent Publication No. 1988-999

### SUMMARY

### Technical Problem

As described above, there is a demand for a technology capable of improving the acoustic characteristics of a speaker.

In view of the circumstances as described above, it is an object of the present technology to provide a speaker and an electronic apparatus that are capable of exhibiting high acoustic characteristics.

### Solution to Problem

In order to achieve the above-mentioned object, a speaker according to an embodiment of the present technology includes: a diaphragm,

The diaphragm includes a surface-layer member and a reinforcing member.

The surface-layer member has a first surface and a second surface on a side opposite to the first surface, a plurality of drive points used as a reference for transmission of vibrations being set at predetermined positions of the second surface.

The reinforcing member includes a plurality of first reinforcing portions and one or more second reinforcing portions and is connected to the second surface of the surface-layer member, the plurality of first reinforcing portions being formed in a vicinity of the respective plurality of drive points, the one or more second reinforcing portions being formed to connect, in a state of being spaced apart from the second surface, between the plurality of first reinforcing portions.

In this speaker, a reinforcing member is connected to a surface-layer member. Then, first reinforcing portions are formed in the vicinity of a plurality of drive points set on the surface-layer member, and a second reinforcing portion is formed to connect between the first reinforcing portions. Further, the second reinforcing portion is connected in a state of being spaced apart from the surface-layer member to the first reinforcing portions. As a result, it is possible to suppress the influence of a natural vibration and exhibit high acoustic characteristics.

The speaker further includes: an actuator; and a plurality of transmission members.

The actuator generates a vibration.

The plurality of transmission members is disposed on a side of the second surface with reference to the plurality of drive points and transmits the vibration generated by the actuator to the diaphragm.

In this case, the first surface may have a planar shape. Further, each of the plurality of transmission members may transmit a vibration along a direction perpendicular to the first surface to the diaphragm.

The plurality of drive points may be set at positions of nodes of a natural vibration generated in the surface-layer member.

The plurality of first reinforcing portions may hold the plurality of transmission members.

One or more natural-vibration suppression points may be set at predetermined positions of the second surface. In this case, the speaker may further include one or more natural-vibration suppression portions that are disposed on a side of the second surface with reference to the one or more natural-vibration suppression points and connected to the diaphragm.

The one or more natural-vibration suppression portions may be formed such that no tension along a direction perpendicular to the first surface is applied to the surface-layer member.

The one or more second reinforcing portions may be formed at positions facing the one or more natural-vibration suppression points.

The one or more natural-vibration suppression portions may include a vibration damping member disposed between the second surface and the second reinforcing portion.

The one or more natural-vibration suppression points may be set at positions of antinodes of a natural vibration generated in the surface-layer member.

The natural vibration may be at least one of a natural vibration of a (2,0)+(0,2) mode or a natural vibration of a (2,2) mode.

The reinforcing member may be formed by assembling a first member including the first reinforcing portion and a second member including the second reinforcing portion.

The plurality of drive points may be four drive points set to be symmetrical with respect to a center of the second surface. In this case, the plurality of first reinforcing portions may be four first reinforcing portions formed to surround the respective four drive points. Further, the one or more second reinforcing portions may be four second reinforcing portions including two second reinforcing portions extending in a first direction and two second reinforcing portions extending in a second direction perpendicular to the first direction.

The surface-layer member may have a rectangular shape as viewed from a direction perpendicular to the first surface, the rectangular shape having two side portions whose main direction is the first direction and two side portions whose main direction is the second direction.

The one or more natural-vibration suppression points may be set at a center of the second surface and a center of adjacent two drive points of the four drive points.

The surface-layer member may be formed of a metal material, a material having a property of suppressing a higher-order natural vibration mode, or a material having high decorativeness.

The surface-layer member may have at least one of an image display function or a lighting function.

The speaker may further include a substrate for driving the actuator, the substrate being installed on the reinforcing member.

The reinforcing member may be formed by assembling a first member including the first reinforcing portion and a second member including the second reinforcing portion. In this case, the diaphragm may include a shielding part that is connected to each of a peripheral edge portion of the surface-layer member and a peripheral edge portion of the first member and shields an inside of the speaker from an outside air.

The first member may include one or more through holes extending along a direction perpendicular to the first surface, and
the diaphragm may include a pin member that is connected to the second surface of the surface-layer member and disposed to penetrate the one or more through holes of the first member.

An electronic apparatus according to an embodiment of the present technology includes: the speaker; and a control unit.
The control unit controls driving of the speaker.

### BRIEF DESCRIPTION OF DRAWINGS

FIG. 1 is a schematic diagram showing a basic configuration of a speaker according to an embodiment of the present technology.

FIG. 2 is a schematic diagram showing an example of a vibration mode of a natural vibration.

FIG. 3 is a graph showing the frequency-sound pressure property of a vibration (Comparative Example).

FIG. 4 is a diagram when a diaphragm is viewed from the surface side (front side).

FIG. 5 is a diagram when the diaphragm is viewed from the back side (rear side).

FIG. 6 is a diagram when the diaphragm is viewed from an oblique direction on the back side (rear side).

FIG. 7 is a diagram when a surface-layer member is viewed from the back side.

FIG. 8 is a diagram when a first member is viewed from the back side (rear side).

FIG. 9 is a diagram when a second member is viewed from the back side (rear side).

FIG. 10 is a schematic diagram showing the shape of a reinforcing structure obtained by optimization.

FIG. 11 is a diagram when the speaker is viewed from the surface side (front side).

FIG. 12 is a cross-sectional view taken along the line A-A shown in FIG. 11.

FIG. 13 is a perspective view when the speaker is cut diagonally.

FIG. 14 is a cross-sectional view of the speaker cut diagonally.

FIG. 15 is a diagram showing a state in which an edge has been attached to the diaphragm and is a diagram when the diaphragm is cut along a line passing through the center.

FIG. 16 is a diagram showing a state in which a drive bobbin and a vibration suppression bobbin have been attached to the diaphragm and is a diagram when the diaphragm is cut diagonally through the center.

FIG. 17 is a schematic diagram for describing a positioning process of MC-ASSY.

FIG. 18 is a schematic diagram for describing a positioning process of MC-ASSY.

FIG. 19 is a schematic diagram for describing a positioning process of MC-ASSY.

FIG. 20 is a schematic diagram for describing a positioning process of MC-ASSY.

FIG. 21 is a schematic diagram for describing a positioning process of a vibration suppression bobbin.

FIG. 22 is a schematic diagram for describing the positioning process of the vibration suppression bobbin.

FIG. 23 is a schematic diagram for describing the positioning process of the vibration suppression bobbin.

FIG. 24 is a schematic diagram for describing the positioning process of the vibration suppression bobbin.

FIG. 25 is a schematic diagram for describing a positioning and height-adjustment process of a drive bobbin.

FIG. 26 is a schematic diagram for describing the positioning and height-adjustment process of the drive bobbin.

FIG. 27 is a schematic diagram for describing the positioning and height-adjustment process of the drive bobbin.

FIG. 28 is a schematic diagram for describing a height-adjustment process of DP-ASSY.

FIG. 29 is a schematic diagram for describing the height-adjustment process of DP-ASSY.

FIG. 30 is a schematic diagram for describing the height-adjustment process of DP-ASSY.

FIG. 31 is a schematic diagram for describing a process of attaching a wiring substrate.

FIG. 32 is a schematic diagram for describing a process of connecting a drive bobbin and a vibration suppression bobbin to a diaphragm.

FIG. 33 is a schematic diagram for describing a process of attaching a surface-layer member.

FIG. 34 is a schematic diagram for describing a process of attaching a terminal substrate.

FIG. 35 is a graph showing the frequency-sound pressure property of a vibration (this embodiment).

FIG. 36 is a schematic diagram showing another variation example of the diaphragm.

FIG. 37 is a schematic diagram showing an example of an electronic apparatus on which the speaker according to the present technology has been mounted.

### DESCRIPTION OF EMBODIMENTS

Hereinafter, an embodiment according to the present technology will be described with reference to the drawings.

### Basic Configuration of Speaker

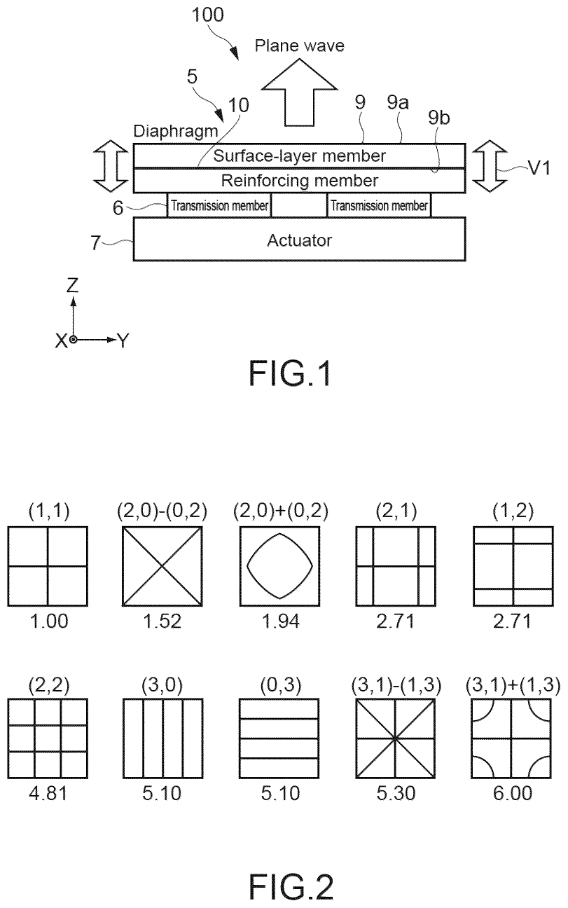

FIG. 1 is a schematic diagram showing a basic configuration of a speaker according to an embodiment of the present technology.

A speaker 100 includes a diaphragm 5, a plurality of transmission members 6, and an actuator 7.

The diaphragm 5 includes a surface-layer member 9 and a reinforcing member 10.

The surface-layer member 9 has a radiation surface 9a having a planar shape and an internal surface 9b on the side opposite to the radiation surface 9a. The radiation surface 9a and the internal surface 9b respectively correspond to an embodiment of the first surface and the second surface according to the present technology.

The reinforcing member 10 is a member that reinforces the structure of the diaphragm 5 and is connected to the internal surface 9b of the surface-layer member 9. The reinforcing member 10 will be described below in detail.

The actuator 7 is capable of generating a vibration.

As the actuator 7, for example, an electromagnetic actuator that includes a permanent magnet and a voice coil and generates a vibration by the action of a magnetic circuit is used. The present technology is not limited thereto, and an arbitrary actuator such as a piezoelectric actuator in which a piezoelectric element is used may be used.

The plurality of transmission members 6 is disposed on the side of the internal surface 9b of the surface-layer member 9 and transmits the vibration generated by the actuator 7 to the diaphragm 5. The plurality of transmission members 6 is disposed with reference to a plurality of drive points described below.

The plurality of transmission members 6 is connected to, for example, the reinforcing member 10. The present technology is not limited thereto, and the plurality of transmission members 6 may be connected to both the reinforcing member 10 and the surface-layer member 9. Alternatively, the plurality of transmission members 6 may be connected to only the surface-layer member 9.

Further, for example, each of the plurality of transmission members 6 is connected to a vibration output unit (not shown) that outputs a vibration of the actuator 7. Alternatively, a link mechanism capable of transmitting a vibration may be formed between a vibration output unit of the actuator 7 and the plurality of transmission members 6. For example, an arbitrary link mechanism such as a Scott Russell type strict linear motion mechanism and a lazy tong type link mechanism may be used.

Alternatively, the vibration output unit of the actuator 7 may be directly connected to the diaphragm 5. In this case, the actuator 7 itself functions also as the transmission member 6.

Note that in the present disclosure, the configuration and method for connecting a member to another member for fixing is not limited, and an arbitrary method may be adopted. For example, an arbitrary configuration and method such as adhesion using an adhesive material, welding, and connection using a locking member such as a screw may be used.

As shown in FIG. 1, in this embodiment, each of the plurality of transmission members 6 transmits a vibration V1 along a direction perpendicular to the radiation surface 9a of the surface-layer member 9 to the diaphragm 5. As a result, a wavefront close to a plane wave is output from the radiation surface 9a.

Hereinafter, the direction perpendicular to the radiation surface 9a of the surface-layer member 9 will be referred to as the Z direction. Further, the radiation side of a plane wave will be referred to as the upper side or the surface side (front side) in some cases, and the side opposite to the radiation side will be referred to as the lower side or the back side (rear side) in some cases.

Further, the radiation surface 9a of the surface-layer member 9 will be referred to as the XY plane direction.

As the diaphragm of the speaker, those having various shapes and materials can be considered.

A wavefront close to a plane wave can be formed in the diaphragm 5 having the radiation surface 9a on the side that radiates sound to a listener as a plane, as in the speaker 100 according to this embodiment. Hereinafter, such a speaker will be referred to as the flat speaker.

In the case where a wavefront close to a plane wave can be formed, it has a directivity different from that of a cone-shaped diaphragm that forms a wavefront close to a spherical wave.

In the ideal plane wave, the directivity is sharp and sound is radiated only toward the front side perpendicular to the radiation surface. Further, when considering one point away from the speaker, in the plane wave, the damping of sound pressure according to the distance from the speaker is little (only damping due to viscoelasticity of air) as compared with the spherical wave that radiates in a spherical shape and needs to consider diffusion according to the distance.

For this reason, the flat speaker is very effective when sound is desired to be heard only in a specific range and sound is desired to be heard by a distant listener, for example.

As the method of driving a diaphragm, i.e., the method of transmitting a vibration, in the case of forming a flat speaker, various methods are considerable. Among them, a method of driving several points has a cost advantage as compared with a method of driving the entire surface, because the number of costly actuator parts in the entire speaker can be reduced.

Further, it is easier to provide a vibration stroke by using a magnetic circuit in which a voice coil is disposed to be orthogonal to a magnetic gap rather than a planar magnetic field type magnetic circuit that is adopted in some cases when moving the entire surface.

Meanwhile, in the drive method that drives several points of a diaphragm, the area where a driving force is applied to the diaphragm is reduced and the divided vibration is easily excited. Further, the flat speaker is originally more susceptible to the divided vibration because the diaphragm strength is reduced as compared with a diaphragm having a cone shape.

Note that the divided vibration means that a different vibration component is generated in a plurality of regions of the diaphragm due to a natural vibration and a behavior different from a uniform vibration in which the entire diaphragm uniformly vibrates is shown.

In the case where the divided vibration is generated in the diaphragm, a peak or a dip of sound pressure is formed in the resonant band in many cases, which also affects the directivity. For these reasons, it is important to suppress the divided vibration in order to improve the performance of the flat speaker.

As disclosed in Patent Literature 1, it is conceivable to suppress the divided vibration by a material approach.

In the present technology, it is possible to suppress the divided vibration by a newly devised structural approach. Specifically, a new structural approach makes it possible to increase the resonant frequency.

FIG. 2 is a schematic diagram showing an example of a vibration mode of a natural vibration.

FIG. 2 illustrates 10 vibration modes including a basic mode of a square plate with free ends. The lower values in the figure are the frequencies relative to that of the basic mode.

When considering the outer shape of the diaphragm of the speaker, a square is often adopted in order to improve the installability in a device incorporating the speaker and increase the ratio of the area of the diaphragm to the baffle surface when a plurality of speakers is arranged.

Assumption is made that edges attached to the outer circumference of the diaphragm for the purpose of separating the air on the front surface (listener side) and the rear surface (inside the device, the drive actuator side) of the diaphragm are sufficiently soft and do not hinder the piston motion of the diaphragm. In this case, the diaphragm can be regarded as a vibration at free ends and is known to show a vibration mode of a natural vibration as shown in FIG. 2.

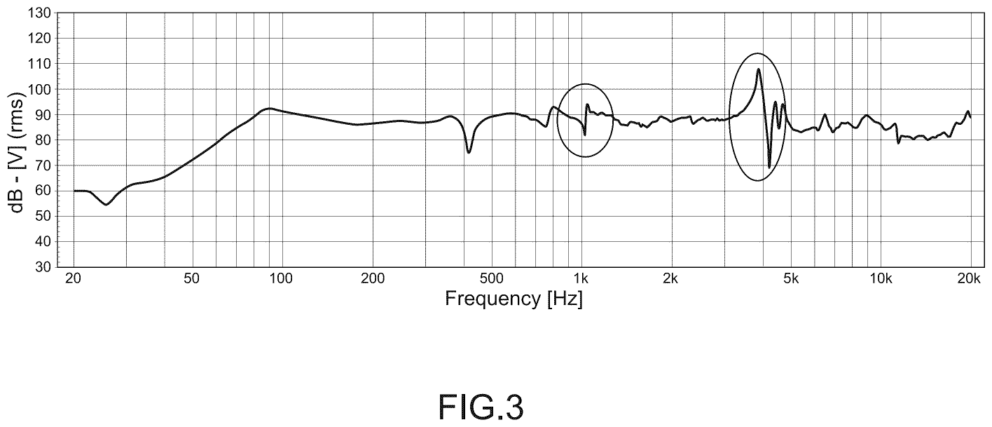

FIG. 3 is a graph showing the frequency-sound pressure property of a vibration.

A speaker in which four actuators were attached to a square diaphragm (without reinforcing member) was created and the diaphragm was driven to radiate sound.

At that time, a natural vibration of the (2,0)+(0,2) mode shown in FIG. 2 was observed near 1 kHz. Further, a natural vibration of the (2,2) mode shown in FIG. 2 was observed near 4 kHz.

As shown in FIG. 3, a peak dip of sound pressure occurred at the frequency at which a natural vibration was observed. Further, the sound pressure in the front direction with respect to the diaphragm was reduced at the frequency at which a natural vibration was observed.

In the present technology, by realizing an appropriate reinforcing structure by the surface-layer member 9 and the reinforcing member 10 illustrated in FIG. 1, it has become possible to sufficiently reduce the influence of the natural vibration illustrated in FIG. 3.

In describing the present technology, first, a natural vibration of the (2,0)+(0,2) mode and a natural vibration of the (2,2) mode are given as examples of the natural vibration to be suppressed.

In the natural vibration mode shown in FIG. 2, the line inside the square is a node of the natural vibration. Then, the central portion of the region separated by the line is an antinode of the natural vibration.

In a natural vibration mode in which curved lines (nodes) are connected to each other such as the (2,0)+(0,2) mode and a natural vibration mode in which glid-like lines (nodes) are given such as the (2,2) mode, it is difficult to suppress the influence of the natural vibration.

In the present technology, it is possible to sufficiently suppress the influence of such a natural vibration mode.

It goes without saying that the application of the present technology is not limited to these natural vibration modes. The present technology described below is applicable to other natural vibration modes.

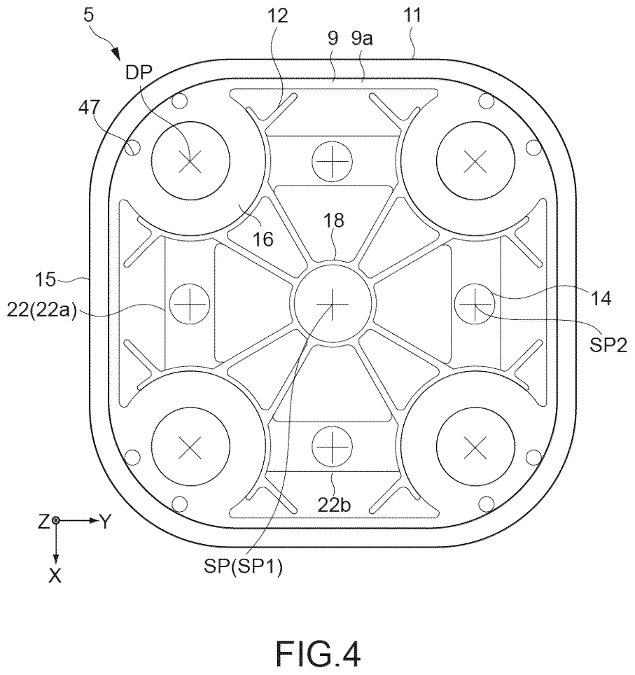

FIG. 4 to FIG. 9 are each a schematic diagram showing a configuration example of the diaphragm 5.

FIG. 4 is a diagram when the diaphragm 5 is viewed from the surface side (front side). In FIG. 4, also a member disposed on the back side of the surface-layer member 9 is illustrated.

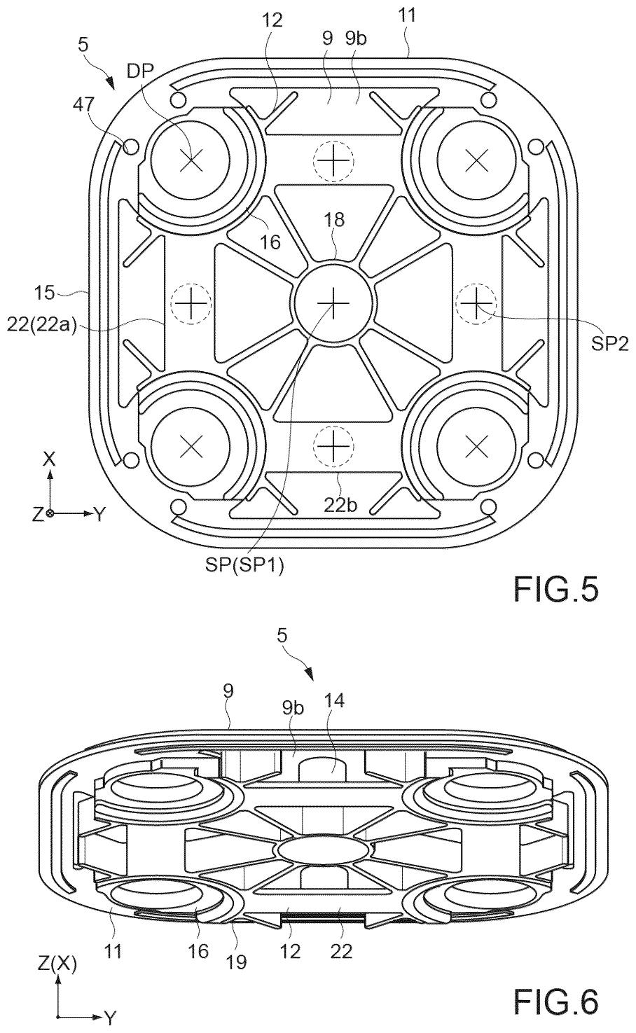

FIG. 5 is a diagram when the diaphragm 5 is viewed from the back side (rear side).

FIG. 6 is a diagram when the diaphragm 5 is viewed from an oblique direction of the back side (rear side).

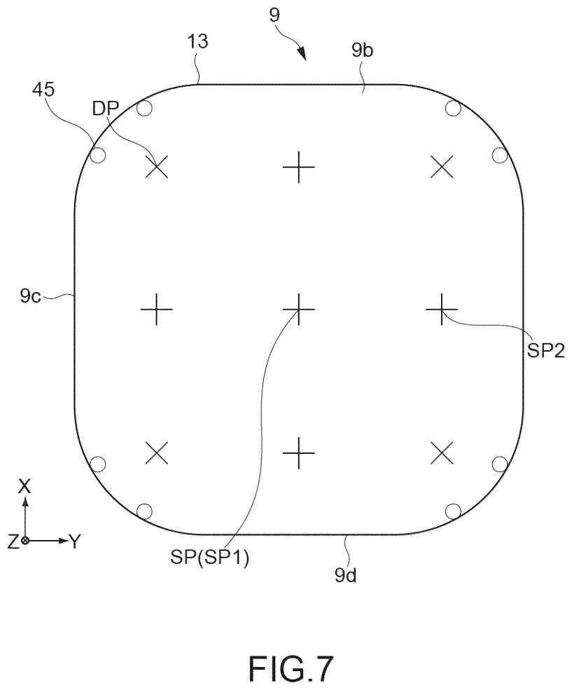

FIG. 7 is a diagram when the surface-layer member 9 is viewed from the back side. FIG. 7 is a front view of the internal surface 9b.

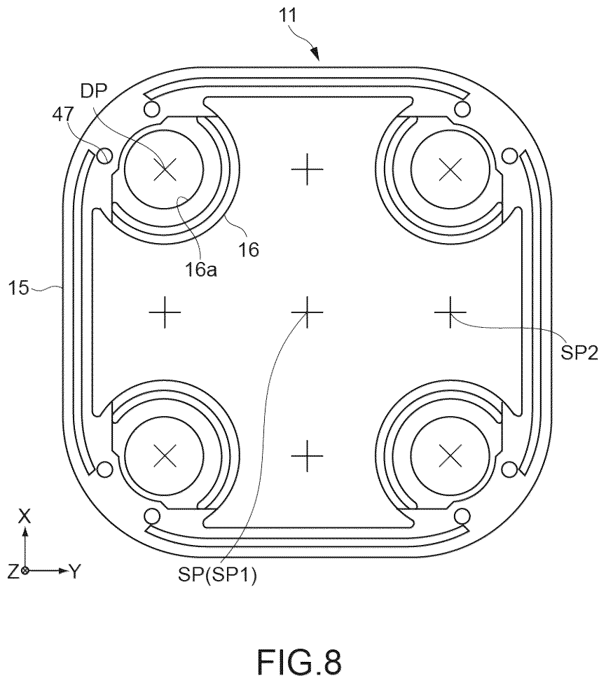

FIG. 8 is a diagram when a first member is viewed from the back side (rear side).

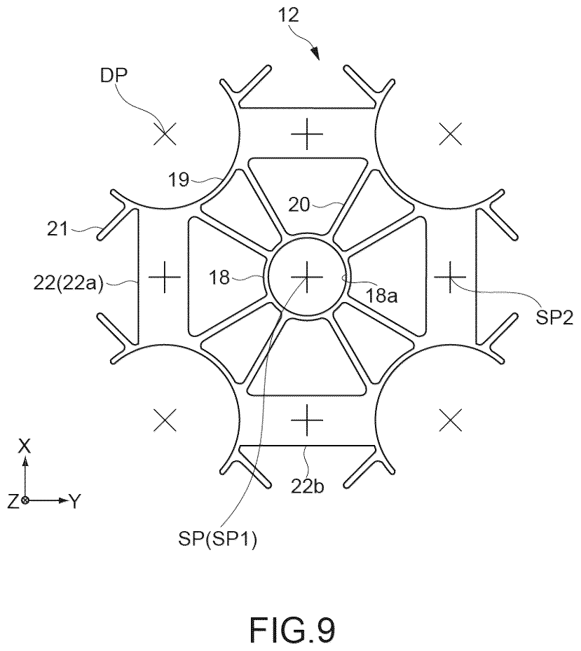

FIG. 9 is a diagram when a second member is viewed from the back side (rear side).

The diaphragm 5 includes the surface-layer member 9, the reinforcing member 10, and a vibration damping member 14.

In this embodiment, the surface-layer member 9 and the reinforcing member 10 are individually formed and the reinforcing member 10 is connected to the internal surface 9b of the surface-layer member 9. That is, the diaphragm 5 has a two-layer structure of the surface-layer member 9 and the reinforcing member 10.

Further, the reinforcing member 10 is formed by assembling a first member 11 shown in FIG. 8 and a second member 12 shown in FIG. 9. Therefore, the diaphragm 5 can be regarded as having a three-layer structure of the surface-layer member 9, the first member 11, and the second member 12.

It goes without saying that the present technology is not limited to such a configuration.

The surface-layer member 9 has the radiation surface 9a that radiates a plane wave and the internal surface 9b. Each of the radiation surface 9a and the internal surface 9b has a planar shape.

As shown in FIG. 7, the surface-layer member 9 has a substantially rectangular shape as viewed from a direction perpendicular to the radiation surface 9a (the Z direction), which is a substantially square shape in this embodiment.

The surface-layer member 9 includes two side portions 9c extending in a first direction and two side portions 9d extending in a second direction orthogonal to the first direction. The four corners of the surface-layer member 9 are formed in a curved shape. That is, a peripheral edge portion 13 of the surface-layer member 9 has a square shape with four rounded corners. In the present disclosure, such a shape is regarded as a substantially rectangular shape (square).

The two side portions 9c correspond to the side portions whose main direction is the first direction. Further, the two side portions 9d correspond to the two side portions whose main direction is the second direction.

Hereinafter, the extending direction (first direction) of the side portions 9c will be referred to as the X direction. The extending direction (second direction) of the side portions 9d will be referred to as the Y direction. It goes without saying that the present technology is not limited to such setting.

As shown in FIG. 7, a plurality of drive points DP is set at predetermined positions of the internal surface 9b.

The drive points DP are points used as a reference of transmission of driving. For example, the drive points DP are set as points where the vibration V1 along the Z direction is directly transmitted. The present technology is not limited thereto, and the drive points DP may be set as points used as a reference for disposing the transmission member 6 that transmits the vibration V1.

Therefore, the vibration V1 is transmitted in some cases not to the drive points DP but to a region with reference to the drive points DP, e.g., a peripheral region of the drive points DP.

The plurality of drive points DP is set at positions of nodes of the natural vibration generated in the surface-layer member 9. In this embodiment, the four drive points DP are set at positions of nodes of the (2,0)+(0,2) mode.

Specifically, the drive points DP are set at positions of nodes (lines) of the (2,0)+(0,2) mode on two diagonal lines of a square, the intersection of the first side portions 9c and the second side portions 9d being the apex of the square. Therefore, the four drive points DP are set so as to be symmetrical with respect to the center of the internal surface 9b.

By setting the drive points DP at positions of nodes of the natural vibration to be suppressed, it is advantageous to suppress the divided vibration. Further, it is also advantageous to suppress the divided vibration by setting the drive points DP so as to be symmetrical with respect to the center of the surface-layer member 9.

Note that the number and position of the drive points DP are not limited and may be arbitrarily set.

Further, in this embodiment, one or more natural-vibration suppression points (hereinafter, referred to simply as the vibration suppression points) SP are set at predetermined positions of the internal surface 9b.

The vibration suppression points SP are points used as a reference for suppressing the component of a natural vibration. For example, the vibration suppression points SP are set as points that directly suppress the component of a natural vibration. The present technology is not limited thereto, and the vibration suppression points SP may be set as points used as a reference for disposing a member, a mechanism, or the like for suppressing the component of a natural vibration.

Therefore, the action of suppressing the component of a natural vibration is exerted in some cases not on the vibration suppression points SP but on a region with reference to the vibration suppression points SP, e.g., a peripheral region of the vibration suppression points SP.

The vibration suppression points SP are set at positions of antinodes of the natural vibration generated in the surface-layer member 9. In this embodiment, the vibration suppression points SP are set at positions of antinodes of the (2,0)+(0,2) mode and positions of antinodes of the (2,2) mode.

Specifically, a vibration suppression point SP1 is set at the center of the internal surface 9b. Further, four vibration suppression points SP2 are set at the centers of two adjacent drive points DP of the four drive points DP.

By setting the vibration suppression points SP at positions of antinodes of a natural vibration to be suppressed, it is advantageous for suppressing the divided vibration.

Note that the number and position of the vibration suppression points SP are not limited and may be arbitrarily set.

Note that in FIG. 2, a natural vibration mode in a square plate with free ends is illustrated. In the case where the reinforcing member 10 is connected to the surface-layer member 9 as in this embodiment, the positions of nodes and antinodes differ in some cases. In this case, for example, the drive points DP and the vibration suppression points SP may be set by calculating, by simulation or the like, the positions of nodes and antinodes of a natural vibration to be suppressed.

The surface-layer member 9 is formed of, for example, a metal material, a material having a property of suppressing a higher-order natural vibration mode, or a material having high decorativeness.

It goes without saying that a material that simultaneously satisfies an arbitrary plurality of conditions of the three conditions of “a metal material”, “a material having a property of suppressing a higher-order natural vibration mode”, and “a material having high decorativeness” may be used.

Examples of the metal material include an aluminum alloy. By using the metal material, it is possible to increase the resonant frequency generated by a natural vibration.

Examples of the material having a property of suppressing a higher-order natural vibration mode include rigid paper having a large internal loss and a carbon panel that is a composite material.

Examples of the material having high decorativeness include a printed board and a cloth. By using the material having high decorativeness, it is possible to mainly improve the design of the radiation surface 9a. As a result, it is possible to improve the design of the diaphragm 5 and the speaker 100.

The thickness of the surface-layer member 9 is designed to be, for example, in the range of 0.5 mm to 2 mm. As a result, it is possible to realize a thin flat speaker. It goes without saying that the thickness of the surface-layer member 9 is not limited and may be arbitrarily set.

Here, the examination of the structure of the first member 11 and the second member 12 constituting the reinforcing member 10 will be described.

The (2,0)+(0,2) mode is also called a ring mode and is a mode in which the central portion and the outer portion of the diaphragm vibrate in opposite phases. Since the portions that move in opposite phases vibrate so as to mutually cancel the radiated sound waves at the frequency at which the (2,0)+(0,2) mode is generated, the radiated sound pressure is reduced.

As a configuration for suppressing the (2,0)+(0,2) mode, four drive points DP are set at positions of nodes of the natural vibration mode with respect to the flat plate member having a substantially square shape, similarly to the surface-layer member 9 shown in FIG. 7. Further, the vibration suppression point SP1 is set at the center that is the position of the antinode of the natural vibration mode.

As will be described below, when forming the speaker 100, drive bobbins are disposed with reference to the four drive points DP. Further, a natural-vibration suppression bobbin (hereinafter, referred to simply as the vibration suppression bobbin) connected only to a damper having no drive system is disposed with reference to the vibration suppression point SP1.
the shape and structure of the diaphragm are optimized to increase the resonant frequency under the conditions that the drive points DP where drive bobbins are disposed are regarded as fixed and a mass is disposed at the vibration suppression point SP1 where the vibration suppression bobbin is used.

As the method for optimization, topology optimization or shape optimization is used.

The front of the diaphragm is kept flat and a reinforcing structure is provided to the internal surface where sound is radiated only inside the device. At this time, the design region for optimization is set such that the area avoids other components of a speaker unit, such as a magnetic circuit and a frame from the stroke range of the diaphragm and has a certain thickness in the depth direction from the front view of the diaphragm.

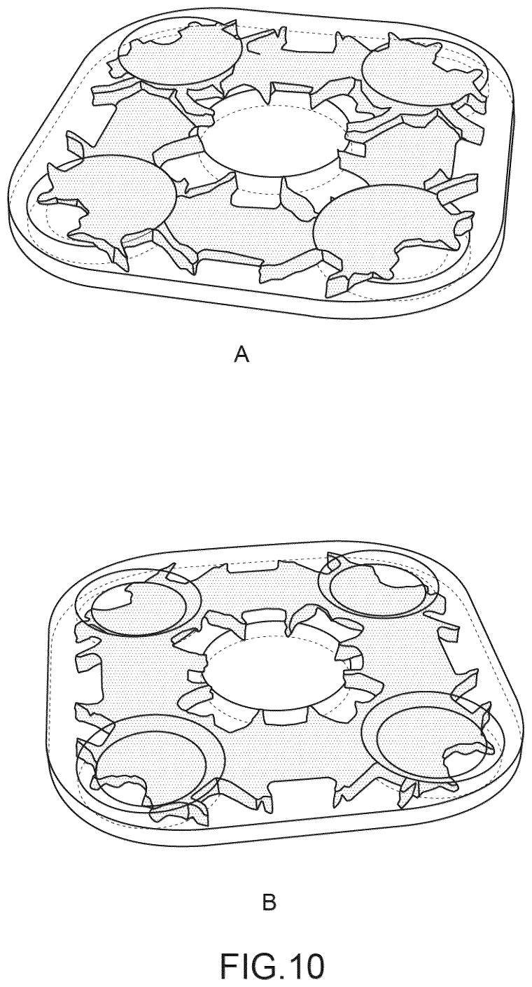

FIG. 10 is a schematic diagram showing the shape of a reinforcing structure obtained by optimization.

Part A of FIG. 10 is a diagram as viewed from the front side and illustrates the shape of the reinforcing member formed on the back side of the flat plate member.

Part B of FIG. 10 is a diagram as viewed from the back surface side and illustrates the shape of the reinforcing member on the internal surface.

The following findings were obtained from the results of optimization shown in Parts A and B of FIG. 10.

It is possible to increase the resonant frequency by reinforcing the vicinity of the four drive points DP.

It is possible to increase the resonant frequency by reinforcing so as to connect between the plurality of drive points DP. That is, a reinforcing structure having a beam shape, when viewing a certain drive point DP, toward the adjacent drive point DP is effective.

The beam-shaped reinforcing structure is formed in a state of being spaced apart from the flat plate member having a substantially square shape. That is, an interval (gap) is formed between the flat plate member and the reinforcing structure. As a result, it is possible to suppress an excessive weight increase and improve the weight-to-efficiency. As a result, it is advantageous for increasing the resonant frequency.

In the (2,2) mode, nodes (lines) appear in a grid pattern and regions between them are antinodes. The point of suppressing the component of the natural vibration generated at the positions of the antinodes was repeatedly studied together with the findings described above. As a result, the following findings were obtained.

A beam-shaped reinforcing structure formed in a state of being spaced apart from a flat member is formed to face the positions of antinodes of the (2,2) mode. That is, a beam-shaped reinforcing structure is formed in a shape passing through the rear side of the antinodes of the (2,2) mode.

Then, a vibration damping member formed of a material having a damping effect is sandwiched between the flat member and the beam-shaped reinforcing structure. As a result, it is possible to suppress the component of a natural vibration.

On the basis of such findings, the configuration of the reinforcing member 10 including the first member 11 and the second member 12 has been newly devised. It will be described below in detail.

FIG. 8 illustrates the positions of the plurality of drive points DP and the vibration suppression points SP with respect to the first member 11 when the speaker 100 is assembled.

As shown in FIG. 8, the first member 11 includes a peripheral edge support portion 15 and four reinforcing portions (hereinafter, referred to as the first reinforcing portions) 16.

The peripheral edge support portion 15 has a ring shape in which the inner side is hollow.

The outer shape of the peripheral edge support portion 15 as viewed from the Z direction is a substantially rectangular shape obtained by enlarging the outer shape of the surface-layer member 9.

The four first reinforcing portions 16 are formed on the inner side of the peripheral edge support portion 15.

The first reinforcing portions 16 are formed in the vicinity of the respective plurality of drive points DP defined on the internal surface 9b of the surface-layer member 9. In this embodiment, the four first reinforcing portions 16 are formed corresponding to the respective four drive points DP.

As shown in FIG. 8, the four first reinforcing portions 16 have a ring shape as viewed from the Z direction and are formed to surround the respective four drive points DP. For example, the first reinforcing portions 16 are formed such that inner circles 16a of the first reinforcing portions 16 coincide with the drive points DP.

The four first reinforcing portions 16 function as a reinforcing structure for reinforcing the vicinity of the drive points DP shown in FIG. 10. The configuration of the first reinforcing portions 16 is not limited and an arbitrary configuration capable of reinforcing the vicinity of the drive points DP may be adopted.

FIG. 9 illustrates the positions of the plurality of drive points DP and the vibration suppression points SP with respect to the second member 12 when the speaker 100 is assembled.

As shown in FIG. 9, the second member 12 includes a central support portion 18, four connecting portions 19, an inner rib portion 20, an outer rib portion 21, and four reinforcing portions (hereinafter, referred to as the second reinforcing portions) 22.

The central support portion 18 is connected to the center of the internal surface 9b of the surface-layer member 9. The central support portion 18 has a ring shape as viewed from the Z direction and is formed to surround the vibration suppression point SP1. For example, the central support portion 18 is formed such that the center of an inner circle 18a of the central support portion 18 coincides with the vibration suppression point SP1.

The four connecting portions 19 are connected to the four first reinforcing portions 16 of the first member 11.

The four connecting portions 19 each have an arc shape as viewed from the Z direction. The four connecting portions 19 are connected to the side surface of the four first reinforcing portions 16.

Further, the four connecting portions 19 are connected to the internal surface 9b of the surface-layer member 9. That is, the four connecting portions 19 are connected in the vicinity of the four drive points DP set on the internal surface 9b of the surface-layer member 9.

The inner rib portion 20 is formed to connect between the central support portion 18 and the four connecting portions 19. When viewed from the Z direction, the inner rib portion 20 extends radially from the central support portion 18 to the peripheral edge side and is connected to the four connecting portions 19.

The inner rib portion 20 is connected to the internal surface 9b of the surface-layer member 9.

The outer rib portion 21 is formed to extend from the four connecting portions 19 to the peripheral edge side.

The outer rib portion 21 is connected to the internal surface 9b of the surface-layer member 9.

The four second reinforcing portions 22 are formed to connect, in a state of being spaced apart from the internal surface 9b of the surface-layer member 9, between the plurality of first reinforcing portions 16. That is, a gap is formed between the second reinforcing portions 22 and the internal surface 9b.

The second reinforcing portions 22 each have a beam structure connecting adjacent two first reinforcing portions 16 of the four first reinforcing portions 16 to each other. The four second reinforcing portions 16 function as the beam-shaped reinforcing member shown in FIG. 10.

In this embodiment, the second reinforcing portions 22 are connected to the first reinforcing portions 16 via the four connecting portions 19.

It is also possible to regard the connecting portions 19 as members that reinforce the vicinity of the drive points DP. That is, an embodiment of the first reinforcing portion according to the present technology may be realized by the connecting portions 19 and the first reinforcing portions 16. In this case, the second reinforcing portions 22 are directly connected to the first reinforcing portions.

As shown in FIG. 9, in this embodiment, the four second reinforcing portions 22 include two second reinforcing portions 22a extending in the X direction (first direction) and two second reinforcing portions 22b extending in the Y direction (second direction) perpendicular to the X direction. When viewed from the Z direction, the four second reinforcing portions 22 are disposed to surround the center (the vibration suppression point SP1) of the internal surface 9b of the surface-layer member 9.

Further, the four second reinforcing portions 22 are formed at positions facing the respective four vibration suppression points SP2 set on the internal surface 9b. That is, when viewed from the Z direction, the four second reinforcing portions 22 are formed to pass through the rear side of the four vibration suppression points SP2.

The configuration of the second reinforcing portions 22 is not limited and an arbitrary beam structure for connecting between the first reinforcing portions 16 may be adopted.

In this embodiment, the central support portion 18, the four connecting portions 19, the inner rib portion 20, and the outer rib portion 21 other than the second reinforcing portions 22 are connected to the internal surface 9b of the surface-layer member 9. As a result, it is possible to sufficiently support the surface-layer member 9.

As shown in FIG. 4 to FIG. 6, the vibration damping member 14 is disposed between the internal surface 9b of the surface-layer member 9 and the second reinforcing portions 22. The vibration damping member 14 is connected to both the internal surface 9b and the second reinforcing portions 22 so as to fill the gap between the internal surface 9b and the second reinforcing portions 22.

The specific configuration of the vibration damping member 14 is not limited and an arbitrary configuration such as a gel/elastomer having viscosity may be adopted.

The vibration damping member 14 is disposed on the side of the internal surface 9b with reference to the vibration suppression points SP and functions as the one or more natural-vibration suppression portions connected to the diaphragm 5.

The natural-vibration suppression portion is formed to be capable of suppressing the component of a natural vibration without interfering with the radiation of a plane wave from the surface-layer member 9.

Specifically, the vibration suppression portion is disposed such that no tension along the Z direction is applied to the surface-layer member 9. That is, the vibration suppression portion is formed such that an excessive force does not act toward the surface side and the back side in a stationary state in which no vibration is transmitted to the diaphragm 5.

The vibration damping member 14 illustrated in FIG. 6 and the like is formed to have the same height as the width between the internal surface 9b and the second reinforcing portions 22 in the stationary state of the diaphragm 5. Then, the vibration damping member 14 is adhered between the internal surface 9b and the second reinforcing portions 22 without being compressed or pulled.

This prevents tension that brings the internal surface 9b and the second reinforcing portions 22 closer to each other or away from each other from acting. As a result, it is possible to suppress the component of a natural vibration without interfering with the radiation of a plane wave from the surface-layer member 9.

The first member 11 and the second member 12 are each formed of, for example, a metal material such as an aluminum alloy.

For example, the first member 11 and the second member 12 can be created by cutting from a plate material. In this embodiment, the first member 11 and the second member 12 are formed as separate members. Therefore, by cutting only from one side, it becomes easy to create each of the first member 11 and the second member 12. As a result, it is possible to sufficiently suppress the occurrence of warpage and the like and create, with high accuracy, the first member 11 and the second member 12 that are thin parts.

The present technology is not limited to such a creation method, and the first member 11 and the second member 12 may be created by casting, die casting, pressing, or the like. Further, the first member 11 and the second member 12 may be integrally created. That is, the reinforcing member 10 may be created without being divided into two parts.

The first member 11 and the second member 12 may be formed of a material having a property of suppressing a higher-order natural vibration mode, or the like, similarly to the surface-layer member 9. It goes without saying that the same material may be used as the materials of the surface-layer member 9, the first member 11, and the second member 12.

In this embodiment, a beam structure is realized by the second reinforcing portions 22. As shown in FIG. 6 and the like, the second reinforcing portion 22 and the connecting portions 19 at both ends thereof form a U shape that opens to the surface side. The U-shaped portion is closed from the surface side by the surface-layer member 9. As a result, a beam structure in which a cavity is formed between the surface-layer member 9 and the second reinforcing portions 22 is realized.

In the case where the surface-layer member 9 and the reinforcing member 10 are integrally created, since an under portion (cavity between the surface-layer member 9 and the second reinforcing portions 22) is generated, it is difficult to perform creation by molding, cutting, or the like or the processing cost significantly increases.

In this embodiment, the surface-layer member 9 and the reinforcing member 10 adopt a multilayer structure. Therefore, it is possible to easily create the diaphragm 5 at low cost. Further, it is possible to create the diaphragm 5 with high accuracy.

It goes without saying that the present technology is applicable also in the case where the surface-layer member 9 and the reinforcing member 10 are integrally formed. That is, in the present disclosure, as a form of connecting members to each other, a case where these members are integrally formed and a connected state is realized is included.

### Configuration Example of Speaker

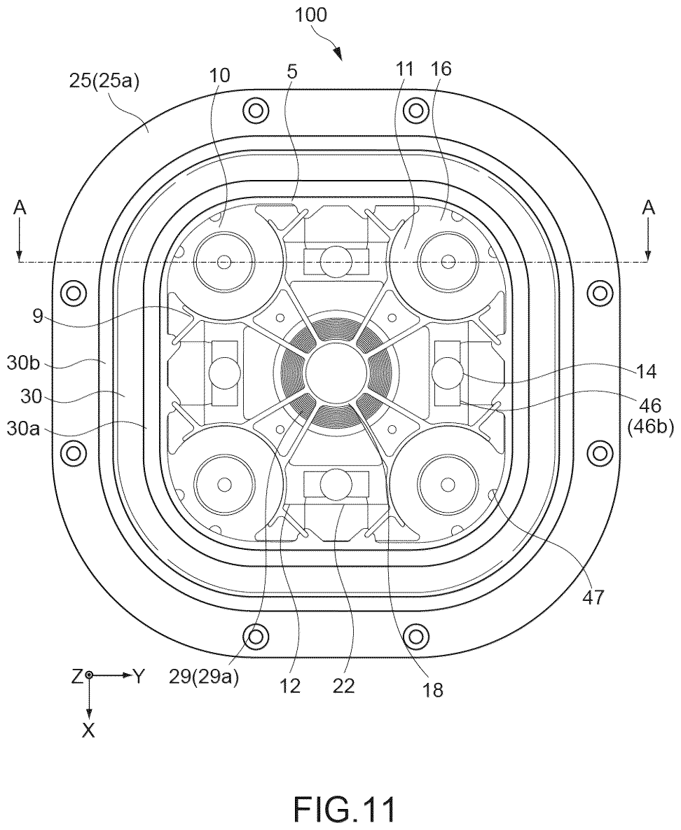

FIG. 11 to FIG. 16 are each a schematic diagram showing a configuration example of the speaker 100.

FIG. 11 is a diagram when the speaker 100 is viewed from the surface side (front side). In FIG. 11, also a member disposed on the back side of the surface-layer member 9 is illustrated.

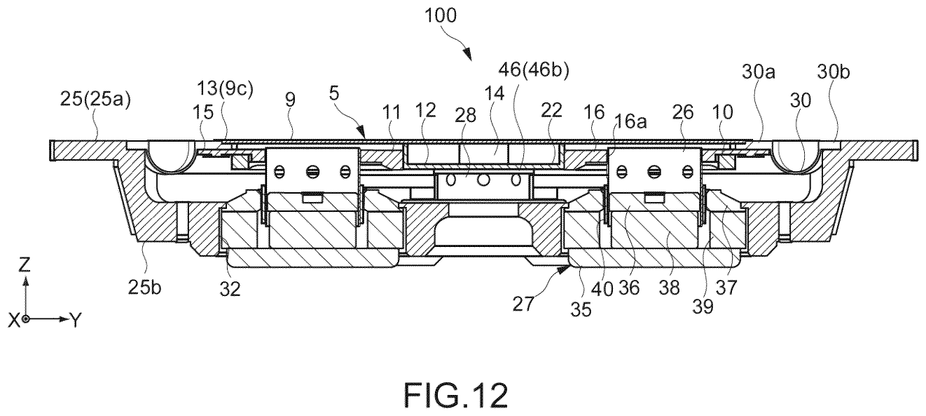

FIG. 12 is a cross-sectional view taken along the line A-A shown in FIG. 11.

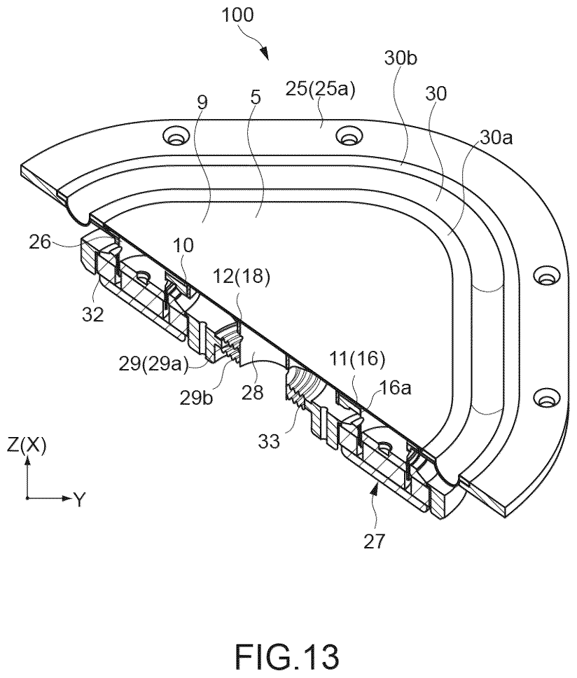

FIG. 13 is a perspective view when the speaker 100 is diagonally cut.

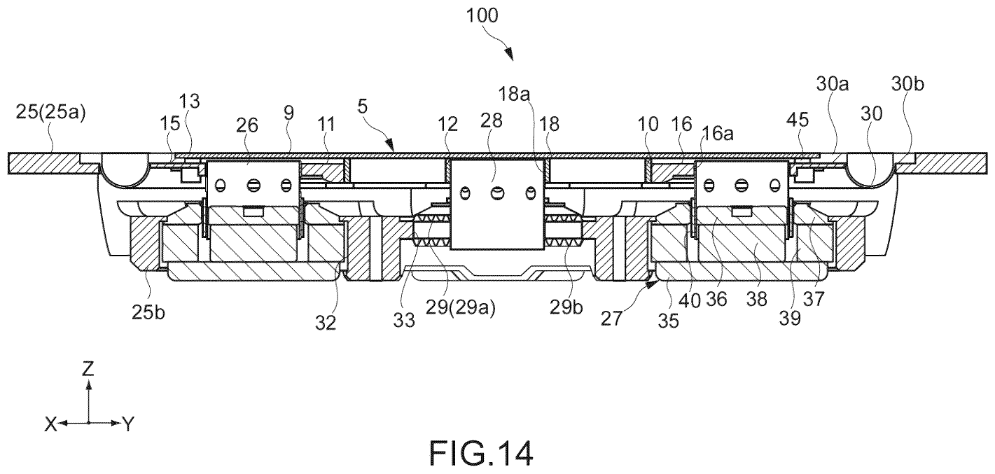

FIG. 14 is a cross-sectional view of the speaker 100 cut diagonally.

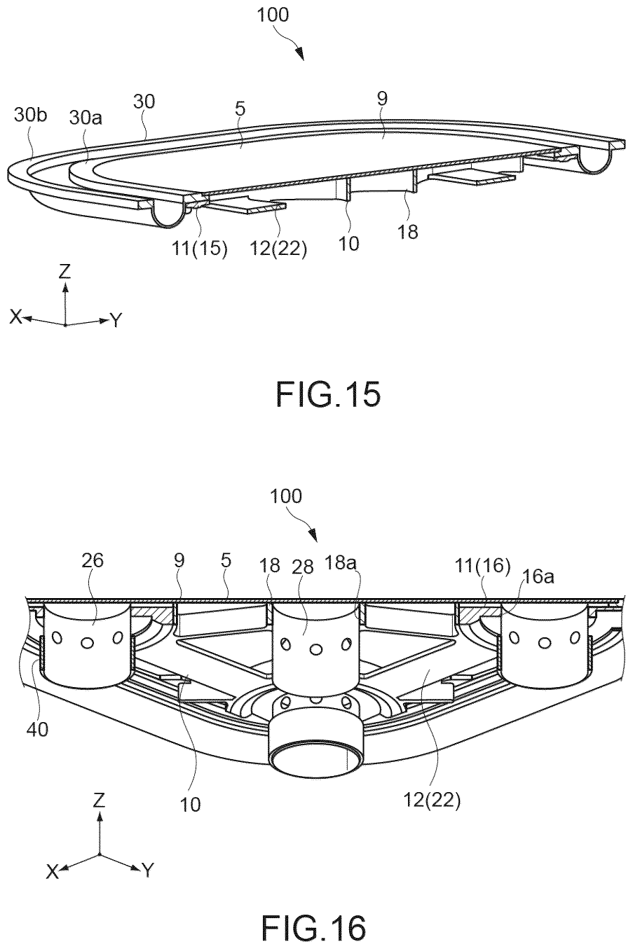

FIG. 15 is a diagram showing a state in which an edge has been attached to the diaphragm 5 and is a diagram when the diaphragm 5 is cut along a line along the Y direction passing through the center.

FIG. 16 is a diagram showing a state in which a drive bobbin and a vibration suppression bobbin have been attached to the diaphragm 5 and is a diagram when the diaphragm 5 is cut diagonally through the center.

The speaker 100 includes the diaphragm 5, a frame 25, four drive bobbins 26, four actuators 27, a vibration suppression bobbin 28, two dampers 29, and an edge 30.

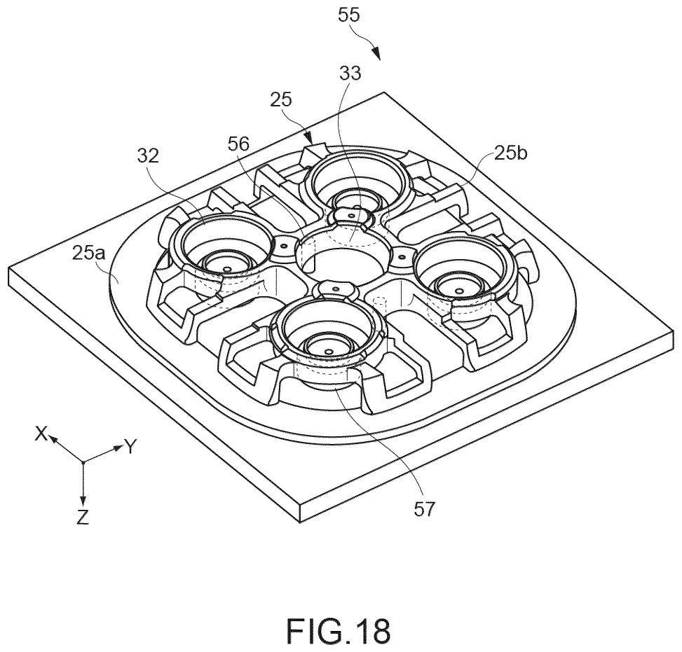

The frame 25 includes a peripheral base portion 25a and a bottom surface base portion 25b (see FIG. 18).

The peripheral base portion 25a has a ring shape in which the inner side is hollow.

When viewed from the Z direction, the outer shape of the peripheral base portion 25a is a substantially rectangular shape obtained by enlarging the outer shape of the surface-layer member 9.

The bottom surface base portion 25b is connected to the peripheral base portion 25a and is configured to form a recessed portion toward the side (the back side) opposite to the side on which a plane wave is radiated.

Four holding units 32 that hold the four actuators 27 and a central hole 33 to which the two dampers 29 are attached are formed in the bottom surface base portion 25b.

The frame 25 is formed of, for example, a metal material such as iron and aluminum. It goes without saying that the present technology is not limited thereto.

The four drive bobbins 26 are connected to the four first reinforcing portions 16 provided in the first member 11 of the diaphragm 5. Specifically, the upper end of the drive bobbins 26 is inserted into and connected to the inner circle 16a of the first reinforcing portions 16.

The four drive bobbins 26 are connected to the first reinforcing portions 16 such that the centers of the bobbins coincide with the drive points DP set on the internal surface 9b of the surface-layer member 9.

The drive bobbins 26 is formed of, for example, a metal material such as aluminum. The present technology is not limited thereto, and another arbitrary material such as a resin material may be used.

In this embodiment, the four drive bobbins 26 function as the plurality of transmission members 6 shown in FIG. 1. As described above, in this embodiment, the plurality of first reinforcing portions 16 holds the plurality of transmission members 6. The first reinforcing portions 16 realize the results of optimization shown in FIG. 10 and make it possible to sufficiently suppress the divided vibration.

The four actuators 27 are attached to the respective four holding units 32 of the frame 25.

In this embodiment, an electromagnetic actuator is used as the actuator 27.

As shown in FIG. 12 and FIG. 14, the actuators 27 each include a yoke 35, a pole piece 36, an outer plate 37, an inner magnet 38, an outer magnet 39, and a voice coil 40. The voice coil 40 is wound around the drive bobbin 26 connected to the first reinforcing portion 16.

The voice coil 40 is inserted into a magnetic gap formed between the pole piece 36 and the outer plate 37.

By driving the actuator 27, it is possible to cause the voice coil 40 and the drive bobbin 26 to vibrate along the Z direction by electromagnetic induction. As a result, it is possible to transmit the vibration V1 along the Z direction to the diaphragm 5 via the drive bobbin 26.

The four actuators 27 are driven in synchronization with each other. That is, the four actuators 27 are driven such that the same vibration V1 is transmitted to the diaphragm 5 along the Z direction. As a result, uniform vibration of the surface-layer member 9 is realized and high acoustic characteristics are exhibited.

The four actuators 27 function as the actuator 7 shown in FIG. 1.

Note that in this embodiment, up to the voice coil 40 has been described as the component of the actuator 27. Therefore, the configuration in which the actuator 7 shown in FIG. 1 (the actuators 27) and the transmission member 6 shown in FIG. 1 (the drive bobbins 26) are connected to each other is adopted.

Meanwhile, the vibration generated by the actuator 27 is output by the drive bobbin 26 to which the voice coil 40 is attached. Therefore, the drive bobbin 26 can be regarded as the vibration output unit that is a component of the actuator 27.

In this case, the vibration output unit (the drive bobbins 26) of the actuator 7 (the actuators 27) can be regarded as the configuration that functions as the transmission member 6 shown in FIG. 1.

The vibration suppression bobbin 28 is connected to the central support portion 18 provided in the second member 12 of the diaphragm 5. Specifically, the upper end of the vibration suppression bobbin 28 is inserted into and connected to the inner circle 18a of the central support portion 18.

The vibration suppression bobbin 28 is connected to the central support portion 18 such that the center of the bobbin coincides with the vibration suppression point SP1 set on the internal surface 9b of the surface-layer member 9.

The vibration suppression bobbin 28 is formed of, for example, a metal material such as aluminum. The present technology is not limited thereto, and another arbitrary material such as a resin material may be used.

Each of the two dampers 29 is capable of damping a vibration. The two dampers 29 include an inner damper 29a and an outer damper 29b.

The two dampers 29 are configured to connect between the vibration suppression bobbin 28 and the central hole 33 of the frame 25. That is, the side of the outer circumference of the two dampers 29 is connected to the inside of the central hole 33 of the frame 25. Further, the inner peripheral side of the two dampers 29 is connected to the side surface of the vibration suppression bobbin 28.

The material and the like of the dampers 29 are not limited and an arbitrary material capable of exhibiting a damping function may be used.

The vibration suppression bobbin 28 and the two dampers 29 are disposed on the side of the internal surface 9b with reference to the vibration suppression point SP1 and function as the natural-vibration suppression portion connected to the diaphragm 5.

As described above, the natural-vibration suppression portion is disposed such that no tension along the Z direction is applied to the surface-layer member 9.

In this embodiment, the two dampers 29 that are not connected to a drive system are used. Then, the vibration suppression bobbin 28 connected to the two dampers 29 is connected to the central support portion 18 of the second member 12 such that an excessive force does not act toward the surface side and the back side in the stationary state of the diaphragm 5.

As a result, it is possible to suppress the component of a natural vibration without interfering with the radiation of a plane wave from the surface-layer member 9. Note that as a configuration for realizing the vibration suppression portion, another arbitrary configuration may be adopted.

The edge 30 includes an inner peripheral portion 30a and an outer peripheral portion 30b.

When viewed from the Z direction, the shapes of the inner peripheral portion 30a and the outer peripheral portion 30b are each a substantially rectangular shape obtained by enlarging the outer shape of the surface-layer member 9.

The inner peripheral portion 30a of the edge 30 is connected to the peripheral edge support portion 15 of the first member 11. Further, the inner peripheral portion 30a of the edge 30 is connected to the peripheral edge portion 13 including the four side portions 9c and 9d of the surface-layer member 9.

As shown in FIG. 12, FIG. 14, and the like, the peripheral edge support portion 15 of the first member 11 is connected to the back side of the inner peripheral portion 30a of the edge 30. The peripheral edge portion 13 of the surface-layer member 9 is connected to the surface side of the inner peripheral portion 30a. That is, the inner peripheral portion 30a of the edge 30 is supported by the first member 11 and the surface-layer member 9 so as to be sandwiched along the Z direction.

As a result, it is possible to sufficiently prevent air from passing through the front and rear surfaces of the diaphragm 5 and exhibit high acoustic characteristics.

Note that the peripheral edge support portion 15 of the first member 11 corresponds to the peripheral edge portion of the first member 11.

The outer peripheral portion 30b of the edge 30 is connected to the peripheral base portion 25a of the frame 25.

As the material of the edge 30, for example, a plastic material such as urethane is used. It goes without saying that the present technology is not limited thereto.

In this embodiment, the edge 30 functions as the shielding part that shields the inside of the speaker 100 from the outside air. As the shielding part, another part may be used.

Further, in this embodiment, a plurality of pin members 45 and a plurality of substrates 46 are installed in the speaker 100.

As shown in FIG. 4, FIG. 5, and FIG. 8, eight through holes 47 extending along the Z direction are formed in the first member 11. The eight through holes 47 are formed on the outer circumference side than the plurality of drive points DP. In this embodiment, the eight through holes 47 are formed, two by two, in the vicinity of the respective four first reinforcing portions 16 of the peripheral edge support portion 15.

The pin members 45 are inserted into the through holes 47 formed in the first member 11.

As shown in FIG. 7, the pin members 45 are connected to the four corners of the internal surface 9b of the surface-layer member 9.

As described above, the pin member 45 whose one end is connected to the surface-layer member 9 is attached so as to be inserted into the through hole 47 formed in the first reinforcing member 11.

As a result, it is possible to sufficiently support the peripheral edge portion 13 of the surface-layer member 9, i.e., a portion on the outer circumference side than the drive points DP and sufficiently suppress the divided vibration.

Further, as shown in FIG. 14, in this embodiment, the length of the pin member 45 is appropriately specified.

For example, assumption is made that the amplitude of the diaphragm 5 exceeds a predetermined distance when the diaphragm 5 moves toward the actuators 27. In such a case, for example, the length of the pin members 45 is specified such that the pin member 45 comes into contact with the frame 25 and the member constituting the magnetic circuit before the drive bobbin 26 comes into contact with the yoke 35 constituting the magnetic circuit.

By using the pin member 45 as a stopper as described above, it is possible to protect the lower end portion of the drive bobbin 26. That is, it is possible to prevent damage and the like due to an excessive amplitude of the actuator 27.

The pin members 45 are each formed of, for example, a metal material or a material having a property of suppressing a higher-order natural vibration mode, similarly to the surface-layer member 9. It goes without saying that the pin member 45 may be formed of a material different from that of the surface-layer member 9.

The pin members 45 and the surface-layer member 9 may be integrally created.

Note that in FIG. 6, illustration of the through holes 47 formed in the first member 11 is omitted.

The plurality of substrates 46 is substrates for driving the actuators 27 installed in the reinforcing member 10.

In this embodiment, as the plurality of substrates 46, four terminal substrates 46a installed in the frame 25 and four wiring substrates 46b installed in the reinforcing member 10 are installed (see FIG. 31 and FIG. 34).

The four terminal substrates 46a are disposed at the intermediate positions of the four holding units 32, which are peripheral edge portions of the bottom surface base portion 25b of the frame 25.

The four wiring substrates 46b are installed in the four second reinforcing portions 22 of the second member 12. The wiring substrates 46b are disposed at the positions on the back side of the vibration damping member 14 disposed in the second reinforcing portions 22. Note that in FIG. 11, the wiring substrate 46b disposed on the back side of the second reinforcing portions 22 is illustrated.

In this embodiment, a wiring for driving the actuator 27 is formed using a tinsel wire. By installing the wiring substrates 46b in the second reinforcing portions 22, wiring becomes easy and it is possible to simplify the process of assembling the speaker 100.

Further, the terminal substrate 46a is disposed at a position outside the wiring substrate 46b and the other end of the tinsel wire is connected thereto. This point is also advantageous in making wiring easy.

Note that in the reinforcing member 10, the positions where the wiring substrates 46b are installed are not limited. The wiring substrates 46b may be installed at positions different from those of the second reinforcing portions 22.

The wiring substrates 46b can be referred to also as landing substrates.

In the case of using a tinsel wire for wiring, an electrically conductive part cannot be disposed in the locus where the tinsel wire can move in order to prevent a short circuit. It is possible to sufficiently prevent the short circuit by forming portions of the surface-layer member 9 and the reinforcing member 10 that can come into contact with the tinsel wire with materials that do not have electrical conduction or applying surface treatment such as painting and alumite treatment thereon.

### Method of Producing Speaker

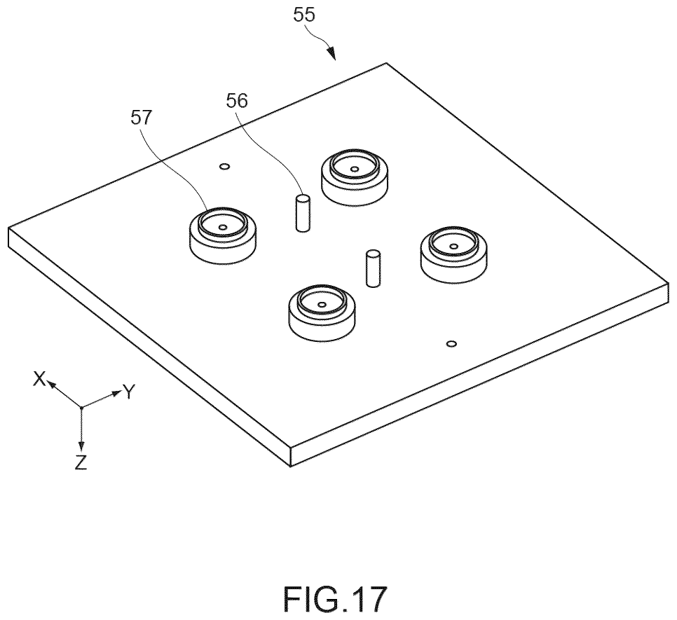

An example of the method of producing the speaker 100 will be described with reference to FIG. 17 to FIG. 34.

The XYZ coordinates in the figures correspond to the XYZ coordinates set for the diaphragm 5 and the speaker 100 shown in FIG. 4, FIG. 11, and the like.

In the following, of the diaphragm 5, the reinforcing member 10 (the first member 11 and the second member 12) will be referred to as the DP-ASSY (Diaphragm-Assembly) 50 in some cases. Further, the parts constituting the magnetic circuit of the yoke 35, the pole piece 36, the outer plate 37, the inner magnet 38, and the outer magnet 39 will be referred to as the MC-ASSY (Magnetic-Circuit-Assembly) 51 in some cases.

FIG. 17 is a schematic diagram showing a jig 55 for positioning the MC-ASSY 51.

A positioning pin 56 and four positioning jigs 57 are provided in the jig 55.

As shown in FIG. 18, the frame 25 is disposed in accordance with the positioning pin 56.

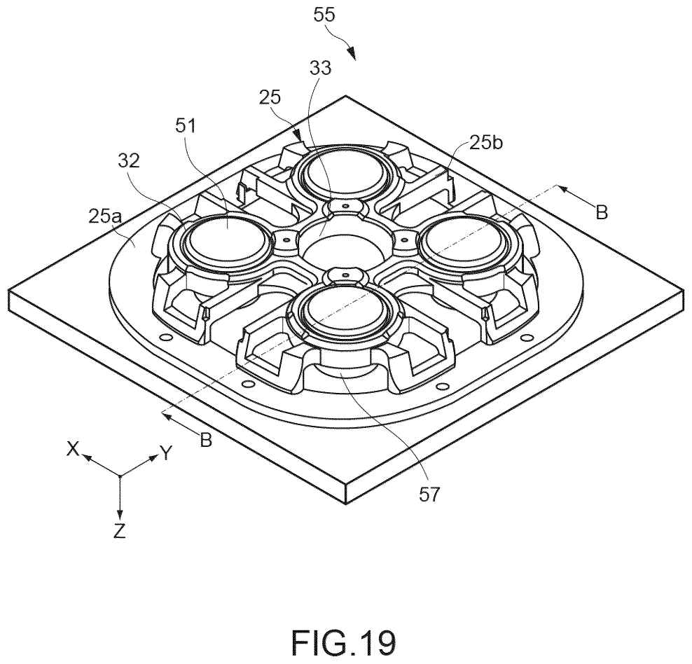

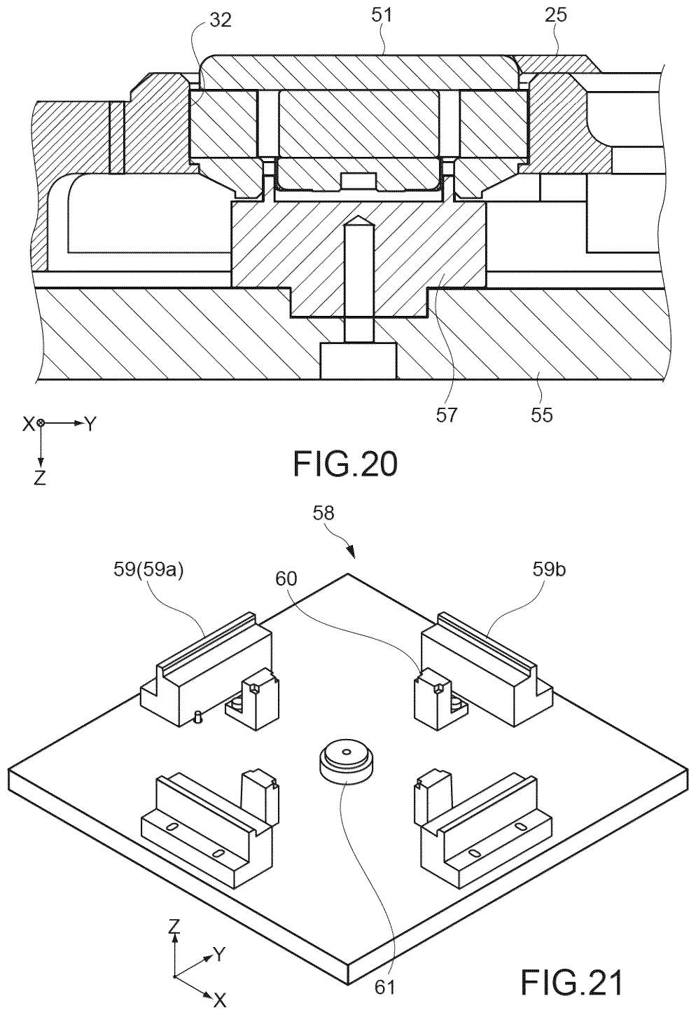

As shown in FIG. 19 and FIG. 2, the MC-ASSY 51 is attached to the four positioning jigs 57 and the MC-ASSY 51 is connected to the holding units 32 of the frame 25. Note that FIG. 20 is a cross-sectional view taken along the line B-B of FIG. 19.

By using the jig 55, it is possible to position the MC-ASSY 51 with high accuracy.

FIG. 21 is a schematic diagram showing a jig 58 for positioning the vibration suppression bobbin 28.

Four outer blocks 59, four inner blocks 60, and a positioning jig 61 are provided in the jig 58.

The four outer blocks 59 and the four inner blocks 60 have a function of fixing the frame 25.

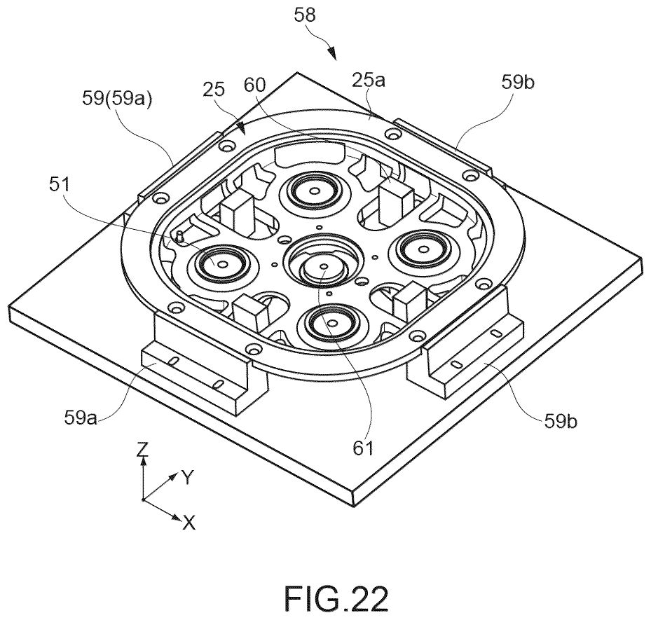

As shown in FIG. 22, the frame 25 to which the MC-ASSY 51 has been attached is placed on the jig 58 such that the peripheral base portion 25a of the frame 25 is located between the four outer blocks 59 and the four inner blocks 60. The frame 25 is placed on the jig 58 with the front and back sides reversed from the state shown in FIG. 19.

For example, two outer blocks 59a adjacent to each other of the four outer blocks 59 are fixed as reference blocks. The other two outer blocks 59b are configured to be movable with respect to the jig 58. By adopting such a configuration, it is possible to sufficiently fix the frame 25 in accordance with the outer shape of the frame 25.

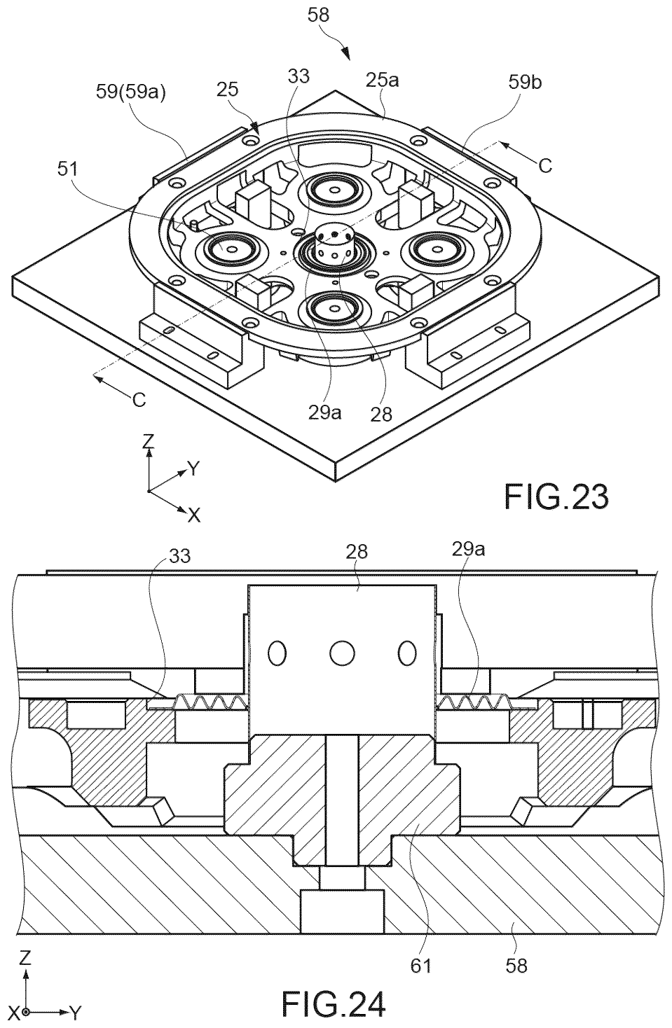

As shown in FIG. 23 and FIG. 24, the vibration suppression bobbin 28 is attached to the positioning jig 61. Then, the inner damper 29a is connected between the vibration suppression bobbin 28 and the central hole 33 of the frame 25. Note that FIG. 24 is a cross-sectional view taken along the line C-C of FIG. 23.

By using the jig 58, it is possible to position the vibration suppression bobbin 28 with high accuracy. Further, it is possible to attach the inner damper 29a with high accuracy.

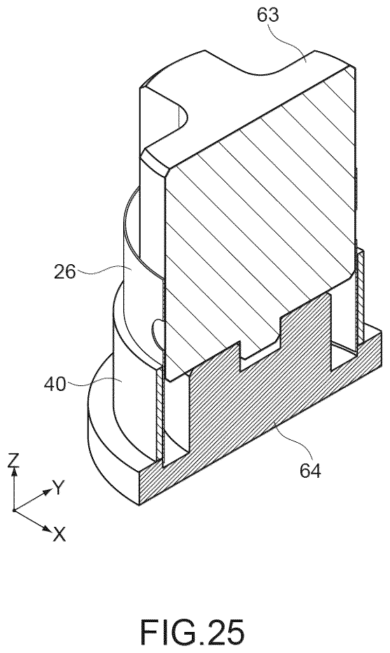

FIG. 25 is a schematic diagram for describing positioning and height-adjustment of the drive bobbins 26.

As described with reference to FIG. 12 and the like, the drive bobbin 26 to which the voice coil 40 has been attached is connected to the first reinforcing portion 16 of the diaphragm 5. The portion of the drive bobbin 26 to which the voice coil 40 is attached is inserted into the magnetic gap of the actuator 27.

Therefore, the MC-ASSY 51 constituting a magnetic circuit and the drive bobbins 26 are disposed in a state of being spaced apart from each other.

In this embodiment, a positioning shaft 63 and a height-adjustment shaft 64 shown in FIG. 25 are used to execute the positioning and height adjustment of the drive bobbins 26 with respect to the MC-ASSY 51,

Note that FIG. 25 illustrates a cross-sectional view along the diameter passing through the center of the drive bobbin 26.

As shown in FIG. 25, the positioning shaft 63 is connected to the upper part of the height-adjustment shaft 64. In this state, the drive bobbin 26 is placed on the height-adjustment shaft 64.

The voice coil 40 is attached to the drive bobbin 26 with reference to the height-adjustment shaft 64. In the height-adjustment shaft 64 illustrated in FIG. 25, the height of the position where the lower end of the drive bobbin 26 is placed and the height of the position where the lower end of the voice coil 40 abuts are appropriately designed.

Therefore, by attaching the voice coil 40 with reference to the height-adjustment shaft 64, it is possible to adjust the height of the voice coil 40 with respect to the drive bobbin 26 to an appropriate position.

The upper end of the drive bobbin 26 placed on the height-adjustment shaft 64 is temporarily fixed to the positioning shaft 63.

When the upper end portion of the drive bobbin 26 and the positioning shaft 63 are temporarily fixed, the height-adjustment shaft 64 is detached from the positioning shaft 63.

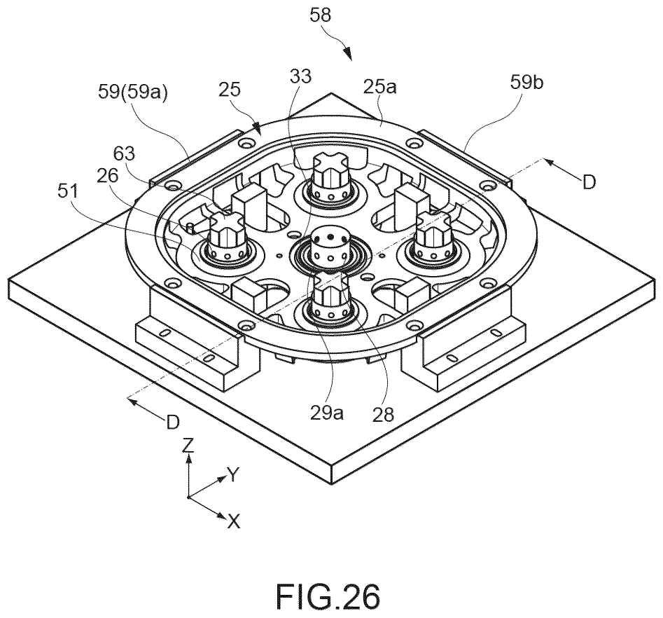

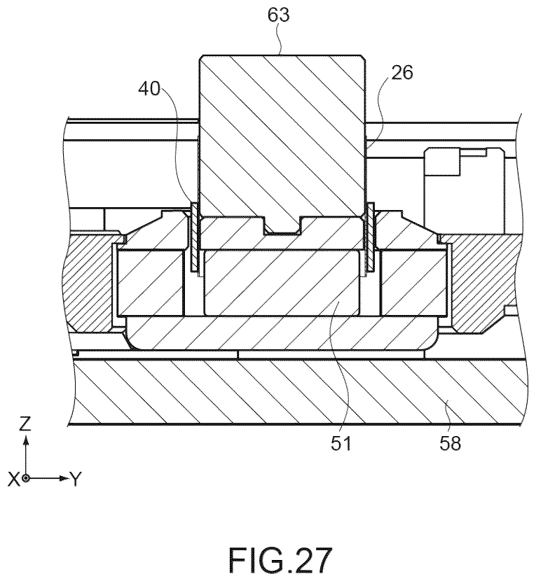

As shown in FIG. 26 and FIG. 27, the positioning shaft 63 in the state where the height-adjustment shaft 64 is detached and the drive bobbin 26 is temporarily fixed is placed on the MC-ASSY 51.

As a result, it is possible to execute the positioning and height-adjustment of the drive bobbin 26 with respect to the MC-ASSY 51 with high accuracy. Note that FIG. 27 is a cross-sectional view taken along the line D-D.

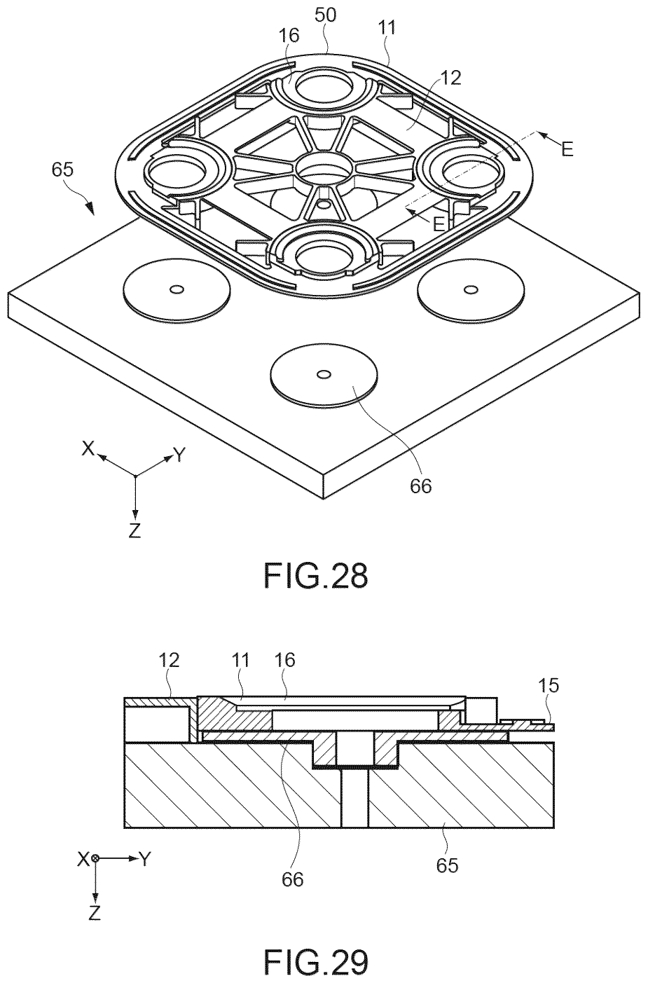

FIG. 28 is a schematic diagram showing a jig 65 for adjusting the height of the DP-ASSY 50.

Four shim rings 66 for height-adjustment are provided in the jig 65.

The DP-ASSY 50 is placed on the jig 65 such that the surface side (the side to be connected to the surface-layer member 9) of the DP-ASSY 50 faces. Further, the DP-ASSY 50 is placed on the jig 65 such that the four first reinforcing portions 16 of the first member 11 are located on the four shim rings 66.

FIG. 29 is a cross-sectional view taken along the line E-E of FIG. 28.

As shown in FIG. 29, the height of the first member 11 is adjusted so as to be a position lower than the surface of the second member 12 to be connected to the surface-layer member 9 by the amount corresponding to the thickness of the shim ring 66. By adjusting the position of the first member 11 to a slightly lower position in this way, it is possible to sufficiently connect the surface-layer member 9 to the second member 12.

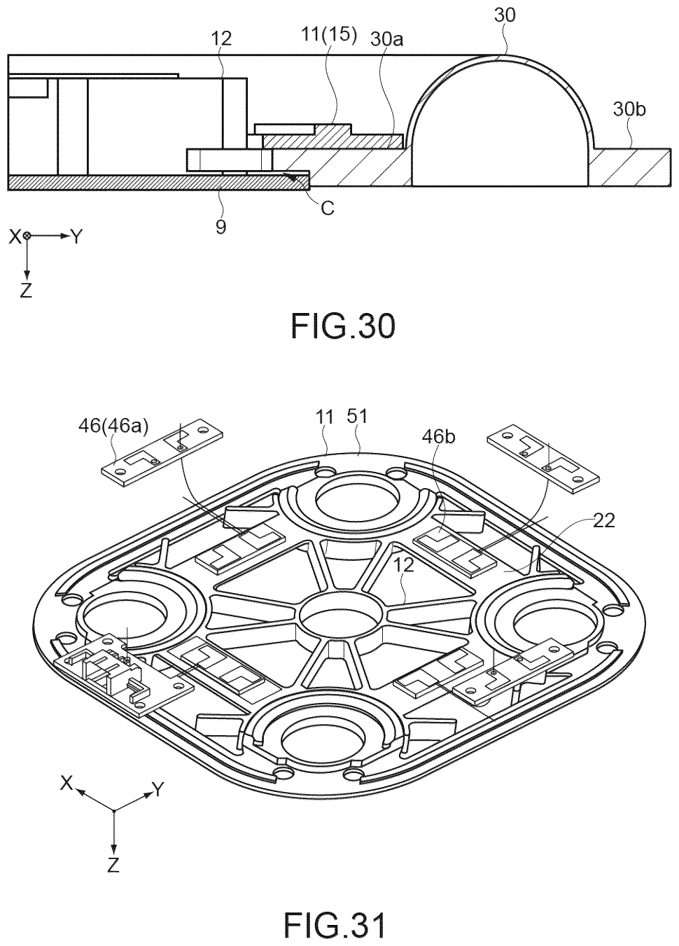

Note that as shown in FIG. 30, the thickness of the shim ring 66, i.e., the offset amount of the height of the first member 11 with respect to the second member 12 is set on the basis of, for example, the size of a clearance C between the edge 30 and the surface-layer member 9.

That is, the offset amount is calculated such that the predetermined clearance C is provided between the edge 30 (the inner peripheral portion 30a) connected to the peripheral edge support portion 15 of the first member 11 and the surface-layer member 9 connected to the second member 12.

Note that the clearance C has the size of approximately 0.2 mm and is formed in order to suppress the influence of part tolerances. For example, in the case where the clearance C is not provided, there is a possibility that when attaching the surface-layer member 9, the surface-layer member 9 is connected to the edge 30 before the second member 12. In this case, the second member 12 is not sufficiently connected to the surface-layer member 9 and the entire DP-ASSY 50 can move.

By forming the clearance C, it is possible to sufficiently connect the surface-layer member 9 to the second member 12 and improve the assembly accuracy of the speaker 100. Note that the clearance C is filled with an adhesive material or the like and the edge 30 and the surface-layer member 9 are sufficiently connected to each other.

As shown in FIG. 31, the wiring substrate 46b is attached to the DP-ASSY 50. The wiring substrate 46b is attached to the back side of the second reinforcing portion 22 of the second member 12.

Further, wiring with the terminal substrate 46a is performed. By determining the wiring length in advance, it is possible to improve the workability.

The DP-ASSY 50 shown in FIG. 31 is placed, from the upper side, on the frame 25 to which the positioning shaft 63 has been attached, which is shown in FIG. 26.

Then, the drive bobbins 26 are connected to the four first reinforcing portions 16 of the first member 11. Further, the vibration suppression bobbin 28 is connected to the central support portion 18 of the second member 12.

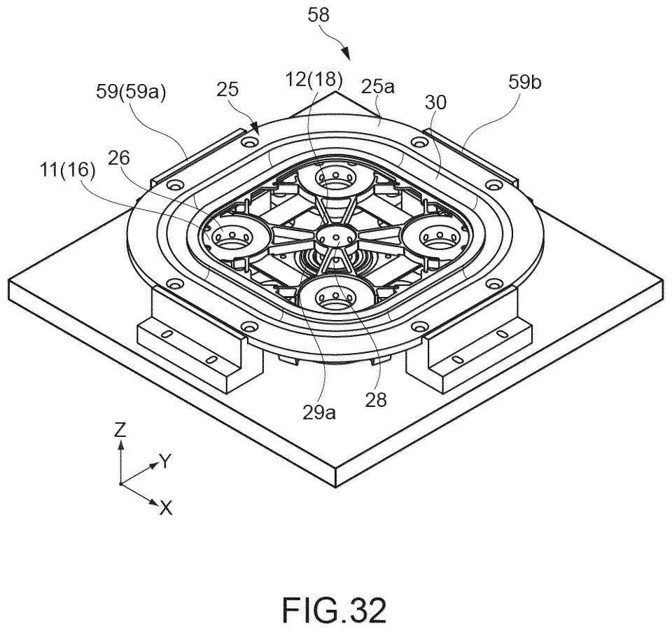

As shown in FIG. 32, the positioning shaft 63 is detached. The first reinforcing portion 16 and the drive bobbin 26 are connected to each other at an appropriate position and an appropriate height. Further, also the vibration suppression bobbin 28 is connected to the second member 12 at an appropriate position and an appropriate height.

Further, as shown in FIG. 32, the edge 30 is connected to the frame 25 and the first member 11.

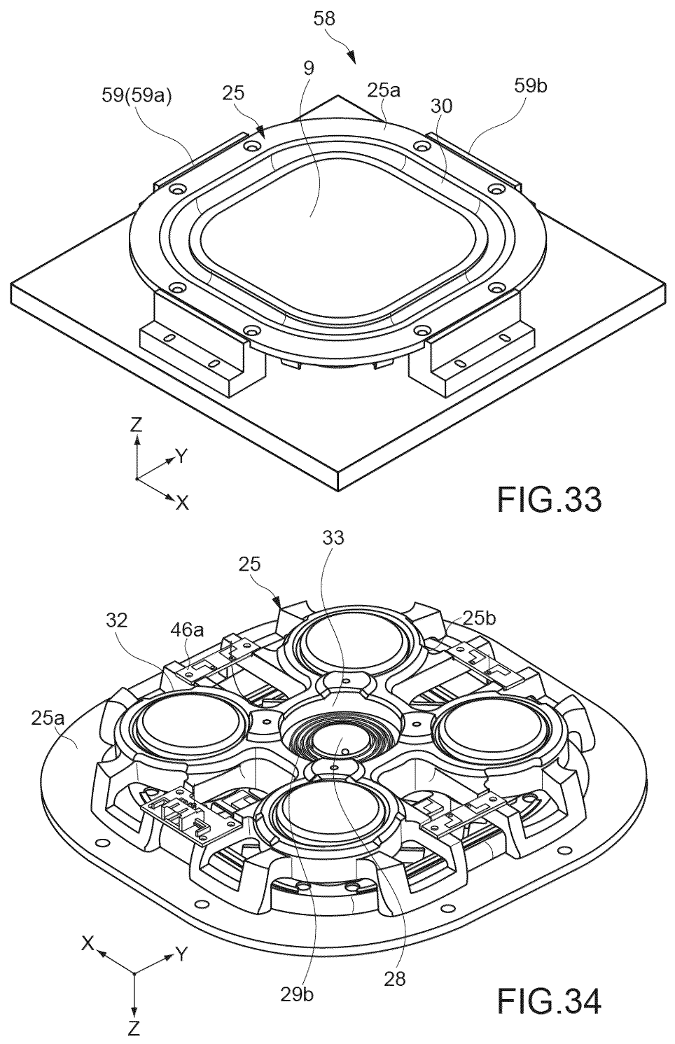

As shown in FIG. 33, the surface-layer member 9 is disposed from above and the internal surface 9b of the surface-layer member 9 is connected to the second member 12. Then, the internal surface 9b of the surface-layer member 9 and the edge 30 are connected to each other.

At that time, the vibration damping member 14 is provided in the second reinforcing portion 22 of the second member 12, and then, the surface-layer member 9 is connected to the second member 12 and the vibration damping member 14.

The present technology is not limited thereto, and, for example, the attachment of the edge 30 shown in FIG. 32 is a post-process and the surface-layer member 9 and the second member 12 are connected to each other first. Then, the vibration damping member 14 may be inserted and connected between the surface-layer member 9 and the second reinforcing portions 22.

Note that in this embodiment, the pin members 45 shown in FIG. 7 are formed on the internal surface 9b of the surface-layer member 9. The surface-layer member 9 is placed such that the pin members 45 are inserted into the through holes 47 formed in the first member 11.

As shown in FIG. 34, the outer damper 29b is connected between the vibration suppression bobbin 28 and the central hole 33 of the frame 25.

Further, the four terminal substrates 46a are connected to the frame 25. In this embodiment, the wiring substrates 46b and the terminal substrates 46a are installed by screwing. It goes without saying that the present technology is not limited thereto.

The tinsel wire is wired and the speaker 100 is produced.

By using various jigs in this way, it is possible to improve the assembly accuracy and improve the overall distortion factor.

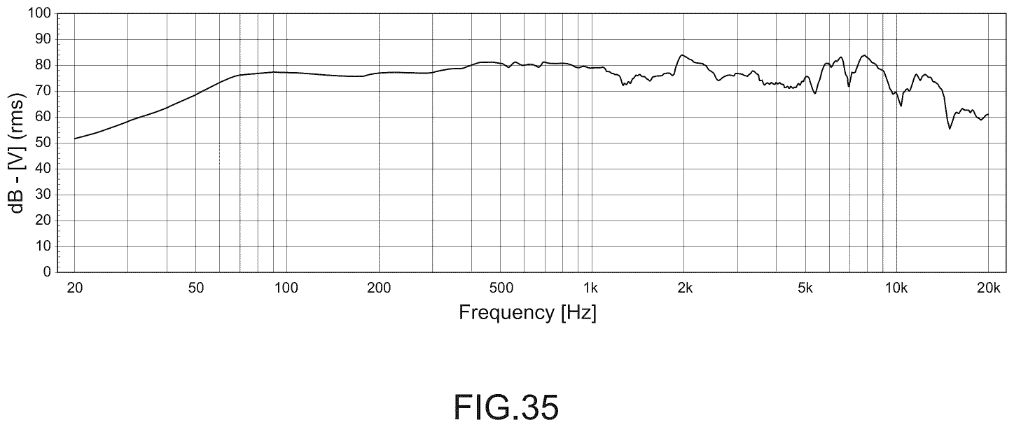

FIG. 35 is a graph showing the frequency-sound pressure property in the speaker 100 according to this embodiment.

It can be seen that the peak dip of sound pressure is suppressed in a wide frequency band up to around 6 kHz, as compared with the frequency-sound pressure property shown in FIG. 3. That is, by using the present technology, it is possible to increase not only the primary resonant frequency but also the higher-order resonant frequency and realize the flat frequency-sound pressure property in a wide frequency band.

As described above, in the speaker 100 according to this embodiment, the reinforcing member 10 is connected to the surface-layer member 9. Then, the first reinforcing portions 16 are formed in the vicinity of the respective plurality of drive points DP set on the surface-layer member 9 and the second reinforcing portions 22 are formed to connect between the first reinforcing portions 16.

Further, the second reinforcing portions 22 are connected, in a state of being spaced apart from the surface-layer member 9, to the first reinforcing portions 16. As a result, it is possible to suppress the influence of a natural vibration and exhibit high acoustic characteristics.

By applying the present technology, it is possible to realize a reinforcing structure for a speaker including a flat diaphragm capable of achieving a directivity close to a plane wave.

In the flat diaphragm, a divided vibration is generated from a relatively low frequency, and in many cases, generation of a peak dip in the frequency property of sound pressure and deterioration of the directivity are problematic.

In the present technology, a three-dimensional reinforcing structure is formed on the rear side while keeping the diaphragm surface on the sound radiation side flat. As a result, it is possible to suppress generation of a divided vibration or reduce the adverse effects of a divided vibration.

That is, it is possible to improve the peak dip in the frequency property of sound pressure generated by the divided vibration, improve the directivity, and improve the distortion.

### Other Embodiments

The present technology is not limited to the embodiment described above and various other embodiments can be realized.

In the embodiment described above, the drive bobbin 26 that functions as a transmission member is connected to the first member 11 included in the reinforcing member 10.

It goes without saying that the present technology is not limited thereto, and the drive bobbin 26 may be directly connected to the surface-layer member 9. Also in this case, the effects described above are exhibited by the reinforcing member 10 including the first reinforcing portions 16 and the second reinforcing portions 22.

For example, the attachment of the edge 30 shown in FIG. 32 is a post-process and the surface-layer member 9 and the second member 12 are connected to each other first. Then, the drive bobbin 26 can be connected to the surface-layer member 9 with an adhesive or the like from the inside of the drive bobbin 26. It goes without saying that the present technology is not limited to such a process.

Further, the first reinforcing portion 16 may be connected to the surface-layer member 9. For example, the reinforcing member 10 is created without providing an offset of the height of the first member 11 to the second member 12 as illustrated in FIG. 29. Then, when attaching the surface-layer member 9, the first member 11 may be attached to the surface-layer member 9 together with the second member 12.

Further, also the vibration suppression bobbin 28 may be directly connected to the surface-layer member 9.

As the surface-layer member 9, a device having an image display function may be used.

For example, an image display device such as a liquid crystal panel and an organic EL (Electro-Luminescence) panel, which has a display surface of a planar shape, and an image display device using an LED (Light Emitting Diode) and an LD (Laser Diode) can be used.

By using these devices, the presentation position of a picture (image) and sound can be matched, a very useful effect is exhibited when combining video content and sound with each other. For example, it is possible to present sound (without divided vibration) better than sound presentation by display direct vibration.

Further, as the surface-layer member 9, a device having a lighting function may be used. It goes without saying that a device having both an image display function and a lighting function may be used.

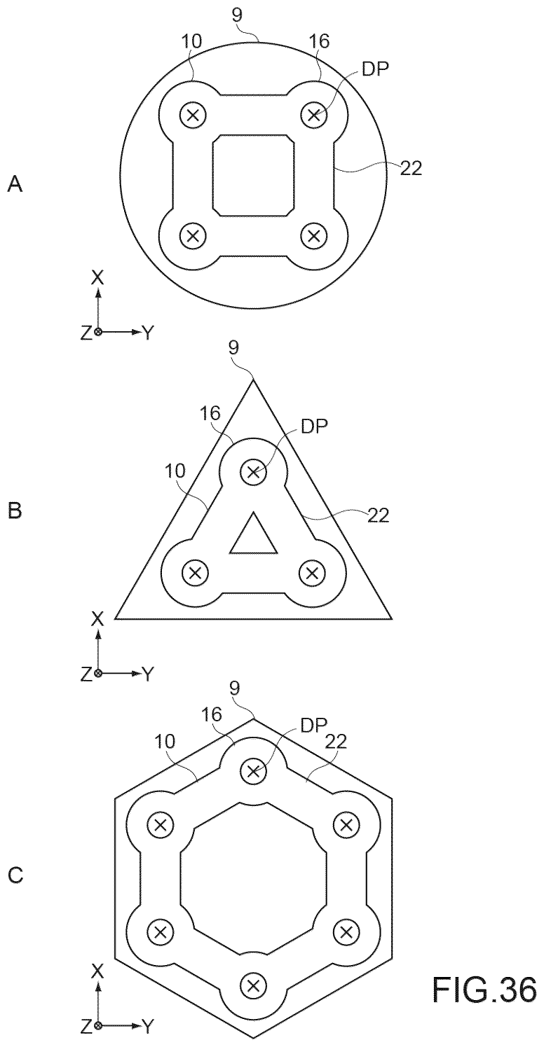

FIG. 36 is a schematic diagram showing another variation example of the diaphragm 5.

As illustrated in Parts A to C of FIG. 36, an arbitrary shape such as a circle, a triangle, and a hexagon can be adopted as the outer shape of the surface-layer member 9 as viewed from the Z direction.

As the reinforcing member 10, a configuration including the plurality of first reinforcing portions 16 formed in the vicinity of the plurality of drive points DP and one or more second reinforcing portions 22 formed to connect, in a state of being spaced apart from the surface-layer member 9, between the plurality of first reinforcing portions 16 only needs to be realized.

Further, even in the case where only one drive point DP is provided on the internal surface 9b of the surface-layer member 9, the present technology can be applied. For example, it only needs to form the first reinforcing portions 16 in the vicinity of the drive point DP and connect the second reinforcing portions 22, in a state of being spaced apart from the surface-layer member 9, to the first reinforcing portions 16.

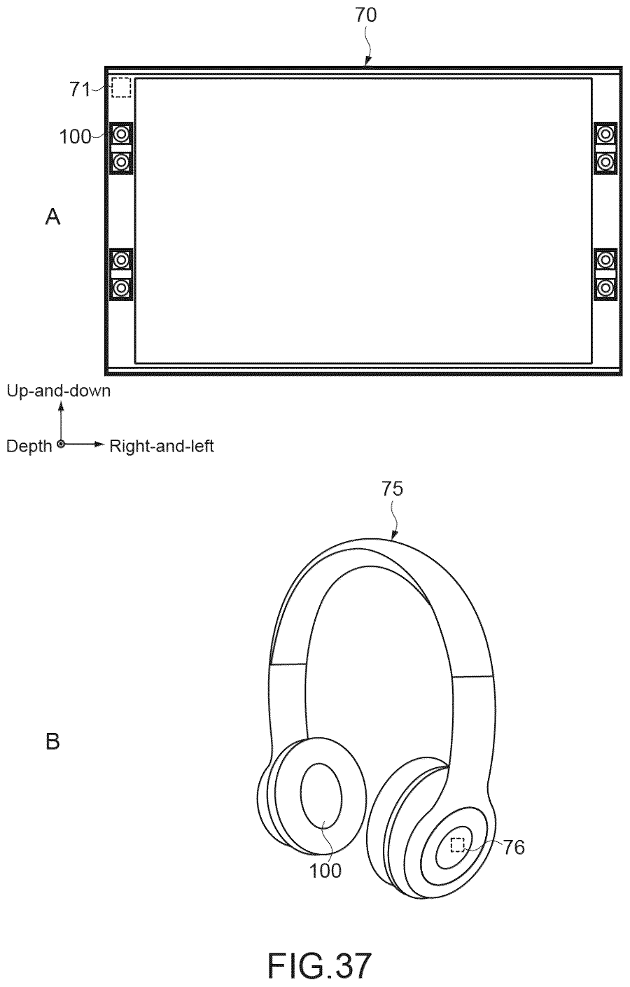

FIG. 37 is a schematic diagram showing an example of an electronic apparatus on which a speaker according to the present technology has been mounted.

For example, as shown in Part A of FIG. 37, the speaker 100 according to the present technology can be mounted on a thin television apparatus 70.

A control unit 71 that controls the driving of the speaker 100 is mounted on the television apparatus 70. The control unit 71 includes, for example, hardware necessary for configurating a computer, such as a CPU, a GPU, a ROM, a RAM, and an HDD. For example, as the control unit 71, hardware such as an FPGA and ASIC may be used. Since the speaker 100 can be made thinner, it is advantageous for making the television apparatus 70 thinner.

Further, as shown in Part B of FIG. 37, the speaker 100 according to the present technology can be mounted on the headphones 75. A control unit 76 that controls the driving of the speaker 100 is mounted on the headphones 75. Since the speaker 100 can be made thinner, it is advantageous for making the headphones 75 thinner.

The type of electronic apparatus on which the speaker 100 according to the present technology can be mounted is not limited. For example, the present technology is applicable to an arbitrary electronic apparatus such as an electronic apparatus such as a mobile phone, a smartphone, a personal computer, a game console, a digital camera, an audio device, a TV, a projector, a car navigation system, a GPS terminal, and a wearable information device (glasses-type, wristband-type) and an IoT device connected to the Internet or the like.

Each of the configurations of the speaker, the diaphragm, the surface-layer member, the reinforcing member, the frame, the actuator, the damper, the electronic apparatus, and the like described with reference to the drawings, the method of producing a speaker, and the like are merely examples, and can be arbitrarily modified without departing from the essence of the present technology. That is, another arbitrary configuration, a production method, and the like for implementing the present technology may be adopted.

In the present disclosure, the word “substantially” is used, it is used only to facilitate the understanding of description, and the use/non-use of the word “substantially” has no special meaning.

That is, in the present disclosure, concepts that define a shape, a size, a positional relationship, a state, and the like, such as “central”, “middle”, “uniform”, “equal”, “same”, “orthogonal”, “parallel”, “symmetrical”, “extended”, “axial direction”, “columnar shape”, “cylindrical shape”, “ring shape”, and “annular shape”, include “substantially central”, “substantially middle”, “substantially uniform”, “substantially equal”, “substantially the same”, “substantially orthogonal”, “substantially parallel”, “substantially symmetrical”, “substantially extended”, “substantially axial direction”, “substantially columnar shape”, “substantially cylindrical shape”, “substantially ring shape”, “substantially annular shape”, and the like.

For example, a state included in a predetermined range (e.g., a range of ±10%) based on “completely central”, “completely middle”, “completely uniform”, “completely equal”, “completely the same”, “completely orthogonal”, “completely parallel”, “completely symmetrical”, “completely extended”, “completely axial direction”, “completely columnar shape”, “completely cylindrical shape”, “completely ring shape”, “completely annular shape”, and the like is also included.

Therefore, even in the case where the word “substantially” is not added, a concept expressed by adding a so-called “substantially” can be included. On the contrary, the complete state is not excluded from the state expressed by adding “substantially”.

In the present disclosure, expressions using “than” such as “larger than A” and “smaller than A” comprehensively include both the concept including the case where it is equivalent to A and the concept not including the case where it is equivalent to A. For example, the phrase “larger than A” is not limited to the case not including being equivalent to A and includes “A or more”. Further, the phrase “smaller than A” is not limited to “less than A” and includes “A or less”.

When implementing the present technology, specific setting and the like only need to be appropriately adopted from the concepts included in “larger than A” and “smaller than A” such that the effects described above are exhibited.

Of the feature portions according to the present technology described above, at least two feature portions can be combined. That is, the various feature portions described in the respective embodiments may be arbitrarily combined without distinguishing from each other in the respective embodiments. Further, the various effects described above are merely illustrative and are not limitative, and another effect may be exhibited.

It should be noted that the present technology may also take the following configurations.

(1) A speaker, including:
a diaphragm that includes
   a surface-layer member that has a first surface and a second surface on a side opposite to the first surface, a plurality of drive points used as a reference for transmission of vibrations being set at predetermined positions of the second surface, and
   a reinforcing member that includes a plurality of first reinforcing portions and one or more second reinforcing portions and is connected to the second surface of the surface-layer member, the plurality of first reinforcing portions being formed in a vicinity of the respective plurality of drive points, the one or more second reinforcing portions being formed to connect, in a state of being spaced apart from the second surface, between the plurality of first reinforcing portions.

(2) The speaker according to (1), further including:
an actuator that generates a vibration; and
a plurality of transmission members that is disposed on a side of the second surface with reference to the plurality of drive points and transmits the vibration generated by the actuator to the diaphragm, in which
the first surface has a planar shape, and each of the plurality of transmission members transmits a vibration along a direction perpendicular to the first surface to the diaphragm.

(3) The speaker according to (2), in which
the plurality of drive points is set at positions of nodes of a natural vibration generated in the surface-layer member.

(4) The speaker according to (2) or (3), in which
the plurality of first reinforcing portions holds the plurality of transmission members.

(5) The speaker according to any one of (2) to (4), in which
one or more natural-vibration suppression points are set at predetermined positions of the second surface, the speaker further including
one or more natural-vibration suppression portions that are disposed on a side of the second surface with reference to the one or more natural-vibration suppression points and connected to the diaphragm.

(6) The speaker according to any one of (2) to (5), in which
the one or more natural-vibration suppression portions are formed such that no tension along a direction perpendicular to the first surface is applied to the surface-layer member.

(7) The speaker according to (5) or (6), in which
the one or more second reinforcing portions are formed at positions facing the one or more natural-vibration suppression points.

(8) The speaker according to any one of (5) to (7), in which
the one or more natural-vibration suppression portions include a vibration damping member disposed between the second surface and the second reinforcing portion.

(9) The speaker according to any one of (5) to (8), in which
the one or more natural-vibration suppression points are set at positions of antinodes of a natural vibration generated in the surface-layer member.

(10) The speaker according to (3) or (9), in which
the natural vibration is at least one of a natural vibration of a (2,0)+(0,2) mode or a natural vibration of a (2,2) mode.

(11) The speaker according to any one of (1) to (10), in which
the reinforcing member is formed by assembling a first member including the first reinforcing portion and a second member including the second reinforcing portion.

(12) The speaker according to any one of (5) to (11), in which
the plurality of drive points is four drive points set to be symmetrical with respect to a center of the second surface,
the plurality of first reinforcing portions is four first reinforcing portions formed to surround the respective four drive points, and
the one or more second reinforcing portions are four second reinforcing portions including two second reinforcing portions extending in a first direction and two second reinforcing portions extending in a second direction perpendicular to the first direction.

(13) The speaker according to (12), in which
the surface-layer member has a rectangular shape as viewed from a direction perpendicular to the first surface, the rectangular shape having two side portions whose main direction is the first direction and two side portions whose main direction is the second direction.

(14) The speaker according to (12) or (13), in which
the one or more natural-vibration suppression points are set at a center of the second surface and a center of adjacent two drive points of the four drive points.

(15) The speaker according to any one of (1) to (14), in which
the surface-layer member is formed of a metal material, a material having a property of suppressing a higher-order natural vibration mode, or a material having high decorativeness.

(16) The speaker according to any one of (1) to (15), in which
the surface-layer member has at least one of an image display function or a lighting function.

(17) The speaker according to any one of (1) to (16), further including
a substrate for driving the actuator, the substrate being installed on the reinforcing member.

(18) The speaker according to any one of (1) to (17), in which
the reinforcing member is formed by assembling a first member including the first reinforcing portion and a second member including the second reinforcing portion, and
the diaphragm includes a shielding part that is connected to each of a peripheral edge portion of the surface-layer member and a peripheral edge portion of the first member and shields an inside of the speaker from an outside air.

(19) The speaker according to any one of (1) to (18), in which
the first member includes one or more through holes extending along a direction perpendicular to the first surface, and
the diaphragm includes a pin member that is connected to the second surface of the surface-layer member and disposed to penetrate the one or more through holes of the first member.

(20) An electronic apparatus, including:
a speaker including
a diaphragm that includes
   a surface-layer member that has a first surface and a second surface on a side opposite to the first surface, a plurality of drive points used as a reference for transmission of vibrations being set at predetermined positions of the second surface, and
   a reinforcing member that includes a plurality of first reinforcing portions and one or more second reinforcing portions and is connected to the second surface of the surface-layer member, the plurality of first reinforcing portions being formed in a vicinity of the respective plurality of drive points, the one or more second reinforcing portions being formed to connect, in a state of being spaced apart from the second surface, between the plurality of first reinforcing portions; and
a control unit that controls driving of the speaker.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

DP drive point
SP a vibration suppression point
V1 a vibration
5 diaphragm
6 transmission member
7, 27 actuator
9 surface-layer member
9a radiation surface
9b internal surface
10 reinforcing member
16 first reinforcing portion
22 second reinforcing portion
26 drive bobbin
27 actuator
28 a vibration suppression bobbin
29 damper
30 edge
45 pin member
46 substrate
47 through hole
70 television apparatus
75 headphones
100 speaker

1. A speaker, comprising:
a diaphragm that includes
a surface-layer member that has a first surface and a second surface on a side opposite to the first surface, a plurality of drive points used as a reference for transmission of vibrations being set at predetermined positions of the second surface, and
a reinforcing member that includes a plurality of first reinforcing portions and one or more second reinforcing portions and is connected to the second surface of the surface-layer member, the plurality of first reinforcing portions being formed in a vicinity of the respective plurality of drive points, the one or more second reinforcing portions being formed to connect, in a state of being spaced apart from the second surface, between the plurality of first reinforcing portions.

2. The speaker according to claim 1, further comprising:
an actuator that generates a vibration; and
a plurality of transmission members that is disposed on a side of the second surface with reference to the plurality of drive points and transmits the vibration generated by the actuator to the diaphragm, wherein
the first surface has a planar shape, and
each of the plurality of transmission members transmits a vibration along a direction perpendicular to the first surface to the diaphragm.

3. The speaker according to claim 2, wherein
the plurality of drive points is set at positions of nodes of a natural vibration generated in the surface-layer member.

4. The speaker according to claim 2, wherein
the plurality of first reinforcing portions holds the plurality of transmission members.

5. The speaker according to claim 2, wherein
one or more natural-vibration suppression points are set at predetermined positions of the second surface, the speaker further comprising
one or more natural-vibration suppression portions that are disposed on a side of the second surface with reference to the one or more natural-vibration suppression points and connected to the diaphragm.

6. The speaker according to claim 2, wherein
the one or more natural-vibration suppression portions are formed such that no tension along a direction perpendicular to the first surface is applied to the surface-layer member.

7. The speaker according to claim 5, wherein
the one or more second reinforcing portions are formed at positions facing the one or more natural-vibration suppression points.

8. The speaker according to claim 5, wherein
the one or more natural-vibration suppression portions include a vibration damping member disposed between the second surface and the second reinforcing portion.

9. The speaker according to claim 5, wherein
the one or more natural-vibration suppression points are set at positions of antinodes of a natural vibration generated in the surface-layer member.

10. The speaker according to claim 3, wherein
the natural vibration is at least one of a natural vibration of a (2,0)+(0,2) mode or a natural vibration of a (2,2) mode.

11. The speaker according to claim 1, wherein
the reinforcing member is formed by assembling a first member including the first reinforcing portion and a second member including the second reinforcing portion.

12. The speaker according to claim 5, wherein
the plurality of drive points is four drive points set to be symmetrical with respect to a center of the second surface,
the plurality of first reinforcing portions is four first reinforcing portions formed to surround the respective four drive points, and
the one or more second reinforcing portions are four second reinforcing portions including two second reinforcing portions extending in a first direction and two second reinforcing portions extending in a second direction perpendicular to the first direction.

13. The speaker according to claim 12, wherein
the surface-layer member has a rectangular shape as viewed from a direction perpendicular to the first surface, the rectangular shape having two side portions whose main direction is the first direction and two side portions whose main direction is the second direction.

14. The speaker according to claim 12, wherein
the one or more natural-vibration suppression points are set at a center of the second surface and a center of adjacent two drive points of the four drive points.

15. The speaker according to claim 1, wherein
the surface-layer member is formed of a metal material, a material having a property of suppressing a higher-order natural vibration mode, or a material having high decorativeness.

16. The speaker according to claim 1, wherein
the surface-layer member has at least one of an image display function or a lighting function.

17. The speaker according to claim 1, further comprising
a substrate for driving the actuator, the substrate being installed on the reinforcing member.

18. The speaker according to claim 1, wherein
the reinforcing member is formed by assembling a first member including the first reinforcing portion and a second member including the second reinforcing portion, and
the diaphragm includes a shielding part that is connected to each of a peripheral edge portion of the surface-layer member and a peripheral edge portion of the first member and shields an inside of the speaker from an outside air.

19. The speaker according to claim 1, wherein
the first member includes one or more through holes extending along a direction perpendicular to the first surface, and
the diaphragm includes a pin member that is connected to the second surface of the surface-layer member and disposed to penetrate the one or more through holes of the first member.

20. An electronic apparatus, comprising:
a speaker including
a diaphragm that includes
a surface-layer member that has a first surface and a second surface on a side opposite to the first surface, a plurality of drive points used as a reference for transmission of vibrations being set at predetermined positions of the second surface, and
a reinforcing member that includes a plurality of first reinforcing portions and one or more second reinforcing portions and is connected to the second surface of the surface-layer member, the plurality of first reinforcing portions being formed in a vicinity of the respective plurality of drive points, the one or more second reinforcing portions being formed to connect, in a state of being spaced apart from the second surface, between the plurality of first reinforcing portions; and
a control unit that controls driving of the speaker.
